(19) United States
(12) Patent Application Publication
(10) Pub. No.: US 2018/0023338 A1
(43) Pub. Date: Jan. 25, 2018

(54) Various Systems of Sculptural Slats and Methods of Manufacture Thereof

(71) Applicant: Bruce M. Werner, Jacksonville, FL (US)

(72) Inventor: Bruce M. Werner, Jacksonville, FL (US)

(21) Appl. No.: 15/657,110

(22) Filed: Jul. 21, 2017

Related U.S. Application Data
(60) Provisional application No. 62/365,458, filed on Jul. 22, 2016.

(51) Int. Cl. E06B 9/303

(52) U.S. Cl. CPC E06B 9/303

(57) ABSTRACT

The present disclosure relates to sculptural slats, wherein varying orientations of sculptural slats within a sculptural slat structure may provide a range of one or both decorative or ambient variable impact. For example, sculptural slats may provide transitional states for a window covering, wherein if the covering is in an open position, the sculptural slat structure may provide an ambient variable impact, and wherein the ambient variable impact may change as the orientation of the sculptural slats is adjusted. In some aspects, the present disclosure provides variations on potential designs, smart technology integration, and applications to other types of slattable objects, including, for example, exterior and interior window coverings, architectural panels, dividers, screens; furniture; and automobiles components. Aftermarket solutions to upgrade traditional slatted structures and slattable objects are described, along with manufacturing methods to create customized sculptural slats and sculptural slat structures based on preferences, installation requirements, and slattable object.

### CROSS-REFERENCE TO RELATED APPLICATION

This application claims priority to and the full benefit of United States Provisional Patent Application Ser. No. 62/365,458, filed Jul. 22, 2016, and titled “VARIOUS SYSTEMS OF SCULPTURAL SLATS AND METHODS OF MANUFACTURE THEREOF”, the entire contents of which are incorporated by reference.

### BACKGROUND OF THE DISCLOSURE

Traditionally, slats are incorporated in a variety of products and systems to manage and control exposure to sunlight, exposure to weather elements, visual privacy, sound transmission, air flow, temperature, physical security, or decorative aesthetics. These products and systems include blinds, shutters, shades, privacy screens, louvers, and doors.

Each of these products use a variety of different control systems. For example, a window blind may be made up of long horizontal strings held together by cords that run through the blind slats, often referred to as a string ladder. These blinds may then be manipulated, such as manually, with a remote, or by some other means, from an open position, with slats positioned and oriented to allow sunlight in, to a closed position where slats overlap and provide some of the benefits listed above.

Despite the decorative function of these products, which include window coverings, most are constricted to operating within a flat, two-dimensional plane. The current solutions on the market are limited to working within the framework of existing technology, or within the framework already provided by traditional solutions to mechanical restraints. Most have been constricted to the confines of the string ladder, limiting creativity and design sensibilities within that paradigm.

What is needed is a way to extend beyond the limits of a window covering's traditional solutions to mechanical constraints by providing structural support to do so while keeping the functionality of a covering. Accordingly, the present disclosure relates to sculptural slats, wherein varying orientations of the sculptural slats within a sculptural slat structure may provide a range of one or both decorative or ambient variable impact. For example, sculptural slats may provide transitional states for a window covering, wherein if the covering is in an open position, the sculptural slat structure may present a first set of characteristics, and wherein the set of characteristics may change as the orientation of the sculptural slats is adjusted.

In some aspects, the present disclosure provides variations on potential designs, smart technology integration, applications to other slat based products and systems, such as blinds, shutters, louvers, grills, vents, wall panels, ceiling panels, privacy screens, room dividers, shades, furniture, and automobiles, including whether the covering is indoor/outdoor or interior/exterior. Aftermarket solutions to upgrade coverings to the coverings described herein are similarly detailed, along with customization options for users to be able to create the slat based products and systems described herein to their personal preferences.

The present disclosure relates to a sculptural slat that may include a substantially planar sheet including four edges, where at least one of the four edges includes a first sculptural edge. In some embodiments, the sculptural slat may also include a first functional zone including a core portion of the sculptural slat and a slattable object integration feature, where the first functional zone is configured to control at least one ambient variable between a first environment and a second environment, and where a slattable object integration mechanism integrates into the slattable object integration feature when the sculptural slat is integrated into a slattable object. In some aspects, the sculptural slat may also include a second functional zone including a first sculptural portion extending from the core portion to the first sculptural edge, where the second functional zone is configured to cast a first sculptural shadow onto one or more adjacent sculptural slats and surfaces in the second environment. Other embodiments of this aspect include corresponding computer systems, apparatus, and computer programs recorded on one or more computer storage devices, each configured to perform the actions of the methods.

In some implementations, the sculptural slat may include a variety of features, such as where one or more ambient variables may include at least a passage of light between the first environment and the second environment; where one or more ambient variables include at least a temperature control between the first environment and the second environment; where one or more ambient variables include at least visual privacy between the first environment and the second environment; where the first functional zone includes a clear zone; where the sculptural slat is configured to fit over a non-sculptural slat; where the substantially planar sheet sculpted in two axes includes variable dimensions along a third axis, and where the core portion is located interior to the substantially planar sheet. In some embodiments, the sculptural slat may include a second sculptural edge opposite to the first sculptural edge, where the substantially planar sheet further includes a third functional zone including a second sculptural portion extending from the core portion to the second sculptural edge. In some aspects, the third functional zone may be configured to cast a second sculptural shadow onto one or more adjacent sculptural slats and surfaces in the second environment. Implementations of the described techniques may include hardware, a method or process, or computer software on a computer-accessible medium.

In some embodiments, a sculptural slat structure may include a slattable object or a plurality of sculptural slats inserted within the slattable object, where each of the plurality of sculptural slats includes a substantially planar sheet including four edges. In some implementations, the sculptural slat structure may also include a first aligned edge where the first aligned edge of adjacent sculptural slats are aligned. In some aspects, the sculptural slat structure may also include a first functional zone including a core portion of the sculptural slat and a slattable object integration feature, where the first functional zone is configured to control at least one ambient variable between a first environment and a second environment. In some embodiments, the sculptural slat structure may also include a second functional zone including a first sculptural portion extending from the core portion to the first sculptural edge, where the second functional zone is configured to cast a first sculptural shadow onto one or more adjacent sculptural slats and surfaces in the second environment. In some aspects, the sculptural slat structure may also include a slattable object integration mechanism connecting the plurality of sculptural slats to the slattable object, where the slattable object integration mechanism connects through the slattable object integration feature. Other embodiments of this aspect include corresponding computer systems, apparatus, and computer programs recorded on one or more computer storage devices, each configured to perform the actions of the methods.

In some implementations, the sculptural slat structure may include a plurality of sculptural slats that are configured for a plurality of orientations within the slattable object. In some embodiments, the sculptural slat structure may have the plurality of orientations controllable through a slattable object integration mechanism. In some implementations, the sculptural slat may include a variety of features, such as where one or more ambient variables include at least a passage of light between the first environment and the second environment, where the ambient variable impact includes one or both a depth of casting of shadow and a level of reflecting light. In some aspects, the sculptural slat structure may include a plurality of orientations that create a plurality of ambient variable impact. In some embodiments, the sculptural slat structure may include a plurality of substantially planar sheets where the substantially planar sheets sculpted in two axes include variable dimensions along a third axis, and where the core portion is located interior to the substantially planar sheet. In some implementations, the sculptural slat structure where each of the plurality of sculptural slats may include a second sculptural edge opposite to the first sculptural edge, where the substantially planar sheet further includes a third functional zone including a second sculptural portion extending from the core portion to the second sculptural edge, where the third functional zone is configured to cast a second sculptural shadow onto one or more adjacent sculptural slats and surfaces in the second environment. Implementations of the described techniques may include hardware, a method or process, or computer software on a computer-accessible medium.

The present disclosure relates to a method for manufacturing a sculptural slat structure that may comprise the method steps of receiving installation data, including one or more height data, width data, and depth data related to an installation site; receiving sculptural edge data, including at least sculptural design data; receiving installation environment data, including at least a first environment data and a second environment data, where the sculptural slat structure is configured to be installed between a first environment and a second environment; receiving slattable object integration mechanism data, including at least a slattable object integration mechanism type; generating rough sculptural slat specification data, including at least sculptural slat width data and sculptural edge design.

In some aspects, the method may include method steps for a first functional zone including a core portion of the sculptural slat and a slattable object integration feature, where the first functional zone is configured to control at least one ambient variable between the first environment and the second environment. In some embodiments, the method may also include a second functional zone including a first sculptural portion extending from the core portion to the first sculptural edge, where the second functional zone is configured to cast a sculptural shadow onto one or more adjacent sculptural slats and surfaces in the second environment. In some implementations, the method may also include generating specifications for the first functional zone, including slattable object integration feature specifications and alignment specifications, where alignment specifications define the first aligned edge and where adjacent sculptural slats are aligned at the first aligned edge when installed. In some embodiments, the method may also include generating refined sculptural slat specifications that define augmentation of the first functional zone and the second functional zone, where the refined sculptural slat specifications are based at least in part on at least one ambient variable, the slattable object integration mechanism, installation environment data, and the rough sculptural slat specification data. Other embodiments of this aspect include corresponding computer systems, apparatus, and computer programs recorded on one or more computer storage devices, each configured to perform the actions of the methods.

In some embodiments, the method may include method steps for generating slattable object specifications, including at least a slattable object type, height data, depth data, and width data, where the slattable object specifications are based at least in part on one or more of the installation data, sculptural edge data, and generated rough sculptural slat specifications; generating sculptural slat installation data, where the sculptural slat installation data includes at least a quantity of sculptural slats and alignment specifications defining at least installation distance between adjacent sculptural slats and installation distance between sculptural slats and the slattable object; and generating slattable object integration mechanism specifications, including at least slattable object integration mechanism type and spacing specifications defining installation areas within the first functional zone.

In some aspects, the method may include method steps where the slattable integration mechanism specifications further include orientation data defining orientation ranges of each of the sculptural slats within the slattable object. In some embodiments, the method may include method steps for receiving ambient variable impact range specifications defining a potential range of ambient variable impact based on one or more of the installation data, sculptural slat material, the installation environment data, and sculptural edge data, where the ambient variable impact range specifications at least partially define the slattable integration mechanism specifications and refined sculptural slat specifications. In some embodiments, the method may include method steps for executing manufacturing of one or more of the sculptural slat, the slattable object, the sculptural slat structure, or slattable object integration mechanism. Implementations of the described techniques may include hardware, a method or process, or computer software on a computer-accessible medium.

### BRIEF DESCRIPTION OF THE DRAWINGS

The accompanying drawings, that are incorporated in and constitute a part of this specification, illustrate several embodiments of the disclosure and, together with the description, serve to explain the principles of the disclosure:

FIG. 1A illustrates an exemplary sculptural slat structure containing a series of sculptural slats.

FIG. 1B illustrates an exemplary cross-sectional side view of sculptural slat structure with a series of sculptural slats.

FIG. 1C illustrates an exemplary sculptural slat, according to some embodiments of the present disclosure.

FIG. 1D illustrates an exemplary slattable object, according to some embodiments of the present disclosure.

FIG. 1E illustrates an exemplary sculptural slat structure, according to some embodiments of the present disclosure.

FIG. 2A illustrates a top view of an exemplary sculptural slat with a continuous surface, according to some embodiments of the present disclosure.

FIG. 2B illustrates a side view of an exemplary sculptural slat with a continuous surface, according to some embodiments of the present disclosure.

FIG. 2C illustrates a perspective view of an exemplary sculptural slat with a variable surface, according to some embodiments of the present disclosure.

FIG. 2D illustrates a top view of an exemplary sculptural slat with a variable surface, according to some embodiments of the present disclosure.

FIG. 2E illustrates a side view of an exemplary sculptural slat with a variable surface, according to some embodiments of the present disclosure.

FIG. 3A illustrates an exemplary series of variable sculptural slat designs, wherein the sculptural slat designs have substantially orthogonal profiles, according to some embodiments of the present disclosure.

FIG. 3B illustrates an exemplary series of variable sculptural slats separated individually, wherein the sculptural slat designs have substantially orthogonal profiles, according to some embodiments of the present disclosure.

FIG. 4A illustrates an exemplary series of variable sculptural slat designs, wherein the sculptural slat designs have substantially orthogonal profiles along their longitudinal edges.

FIG. 4B illustrates an exemplary series of variable sculptural slat designs separated individually, wherein the sculptural slat designs have substantially different angular, non-rectilinear profiles along their longitudinal edges.

FIG. 5A illustrates an exemplary series of variable sculptural slat designs, wherein the sculptural slat designs have substantially different curvilinear, non-rectilinear profiles along their longitudinal edges.

FIG. 5B illustrates an exemplary series of variable sculptural slats separated individually, wherein the sculptural slat designs have substantially different curvilinear, non-rectilinear profiles along two of their longitudinal edges.

FIG. 5C illustrates an exemplary series of sculptural slats with ambient variable impact and associated conditions that may cause the ambient variable impact, according to some embodiments of the present disclosure.

FIG. 5D illustrates an exemplary series of sculptural slats with ambient variable impact and associated conditions that may cause the ambient variable impact, according to some embodiments of the present disclosure.

FIG. 5E illustrates an exemplary series of sculptural slats with ambient variable impact and associated conditions that may cause the ambient variable impact, according to some embodiments of the present disclosure.

FIG. 5F illustrates an exemplary series of sculptural slats with ambient variable impact and associated conditions that may cause the ambient variable impact, according to some embodiments of the present disclosure.

FIG. 6A illustrates a front view of an exemplary series of variable sculptural slat designs, wherein a sculptural slat may have a light source that creates a glowing feature or provides an illuminated sculptural slat.

FIG. 6B illustrates an isometric view of a sculptural slat design, wherein the sculptural slat may have a light source that creates a glowing feature or provides an illuminated sculptural slat.

FIG. 6C illustrates a side view of exemplary sculptural slats, indicating exemplary configurations as to how sculptural slats could host a light-source and how they may connect to one another.

FIG. 6D illustrates a side view of alternative exemplary sculptural slats, indicating exemplary configurations as to how sculptural slats could host a light-source and how they may connect to one another.

FIG. 6E illustrates an exemplary sculptural slat structure containing a series of sculptural slats wherein a sculptural slat may have a light source that creates a glowing feature or provides an illuminated sculptural slat.

FIG. 7 illustrates an exemplary series of variable sculptural slat designs.

FIG. 8A illustrates an exemplary method step for assembling a slattable object with multi-layered distinctive sculptural slat composites using conventional blinds parts, such as a head rail, bottom rail, string ladders, and pull cords.

FIG. 8B illustrates an exemplary method step for assembling a slattable object with multi-layered distinctive sculptural slat composites using conventional blinds parts, such as a head rail, bottom rail, string ladders, and pull cords.

FIG. 8C illustrates an exemplary method step for assembling a sculptural slat structure with multi-layered distinctive sculptural slat composites using conventional blinds parts, such as a head rail, bottom rail, string ladders, and pull cords.

FIG. 8D illustrates an exemplary method step for assembling a sculptural slat structure with multi-layered distinctive sculptural slat composites using conventional blinds parts, such as a head rail, bottom rail, string ladders, and pull cords.

FIG. 8E illustrates an exemplary method step for assembling a sculptural slat structure with multi-layered distinctive sculptural slat composites using conventional blinds parts, such as a head rail, bottom rail, string ladders, and pull cords.

FIG. 8F illustrates a multi-layered sculptural slat joint within a sculptural slat composite that envelops a string ladder rung between a bottom layer and a top layer, wherein both layers may contain the string ladder or be contained within a string ladder.

FIG. 8G illustrates a multi-layered sculptural slat joint within a sculptural slat composite that envelops a string ladder rung between a bottom layer and a top layer, wherein both layers may contain the string ladder or be contained within a string ladder.

FIG. 8H illustrates a multi-layered sculptural slat joint within a sculptural slat composite that envelops a string ladder rung between a bottom layer and a top layer, wherein both layers may contain the string ladder or be contained within a string ladder.

FIG. 8J illustrates a multi-layered sculptural slat joint within a sculptural slat composite that envelops a string ladder rung between a bottom layer and a top layer, wherein both layers may contain the string ladder or be contained within a string ladder.

FIG. 9A illustrates an exemplary method step for a sculptural slat structure assembly wherein a sculptural slat depth is greater than the clear dimensions of a slattable object integration mechanism.

FIG. 9B illustrates an exemplary method step for a sculptural slat structure assembly wherein a sculptural slat depth is greater than the clear dimensions of a slattable object integration mechanism.

FIG. 9C illustrates an exemplary method step for a sculptural slat structure assembly wherein a sculptural slat depth is greater than the clear dimensions of a slattable object integration mechanism.

FIG. 9D illustrates an exemplary method step for a sculptural slat structure assembly wherein a sculptural slat depth is greater than the clear dimensions of a slattable object integration mechanism.

FIG. 9E illustrates an exemplary method step for a sculptural slat structure assembly wherein a sculptural slat depth is greater than the clear dimensions of a slattable object integration mechanism.

FIG. 9F illustrates an exemplary method step for a sculptural slat structure assembly wherein a sculptural slat depth is greater than the clear dimensions of a slattable object integration mechanism.

FIG. 9G illustrates an exemplary method step for a sculptural slat structure assembly wherein a sculptural slat depth is greater than the clear dimensions of a slattable object integration mechanism.

FIG. 10A illustrates an exemplary process flowchart for customizing and ordering sculptural slat structures, according some embodiments of the present disclosure.

FIG. 10B illustrates an exemplary process flowchart for manufacturing customized sculptural slat structures, according some embodiments of the present disclosure.

FIG. 10C illustrates an exemplary process flowchart for generating specifications for manufacturing sculptural slat structures, according some embodiments of the present disclosure.

FIG. 11A illustrates exemplary alternative coverings that may use a series of sculptural slats, according to some embodiments of the present disclosure.

FIG. 11B illustrates exemplary alternative coverings that may use a series of sculptural slats, according to some embodiments of the present disclosure.

FIG. 11C illustrates exemplary alternative coverings that may use a series of sculptural slats, according to some embodiments of the present disclosure.

FIG. 12A illustrates exemplary embodiments of coverings relating to interior architecture that may use a series of sculptural slats.

FIG. 12B illustrates exemplary embodiments of coverings relating to interior architecture that may use a series of sculptural slats.

FIG. 12C illustrates exemplary embodiments of coverings relating to interior architecture that may use a series of sculptural slats.

FIG. 13A illustrates exemplary embodiments of interior or exterior architectural coverings that may use a series of sculptural slats.

FIG. 13B illustrates exemplary embodiments of exterior architectural coverings that may use a series of sculptural slats.

FIG. 13C illustrates exemplary embodiments of exterior architectural coverings that may use a series of sculptural slats.

FIG. 14A illustrates exemplary embodiments of interior furniture that may use a series of sculptural slats.

FIG. 14B illustrates exemplary embodiments of interior furniture that may use a series of sculptural slats.

FIG. 15 illustrates an exemplary vent with a series of sculptural slats.

FIG. 16A illustrates exemplary embodiments of a sculptural slat structure with variable sculptural slat designs, wherein the sculptural slat designs have substantially different curvilinear, non-rectilinear profiles along their longitudinal edges.

FIG. 16B illustrates exemplary embodiments of alternative coverings with variable sculptural slat designs, wherein the sculptural slat designs have substantially different curvilinear, non-rectilinear profiles along their longitudinal edges.

FIG. 16C illustrates exemplary embodiments of alternative coverings with variable sculptural slat designs, wherein the sculptural slat designs have substantially different curvilinear, non-rectilinear profiles along their longitudinal edges.

FIG. 16D illustrates exemplary embodiments of alternative coverings with variable sculptural slat designs, wherein the sculptural slat designs have substantially different curvilinear, non-rectilinear profiles along their longitudinal edges.

FIG. 17A illustrates exemplary embodiments of coverings relating to interior architecture with variable sculptural slat designs, wherein the sculptural slat designs have substantially different curvilinear, non-rectilinear profiles along their longitudinal edges.

FIG. 17B illustrates exemplary embodiments of coverings relating to interior architecture with variable sculptural slat designs, wherein the sculptural slat designs have substantially different curvilinear, non-rectilinear profiles along their longitudinal edges.

FIG. 17C illustrates exemplary embodiments of coverings relating to interior architecture with variable sculptural slat designs, wherein the sculptural slat designs have substantially different curvilinear, non-rectilinear profiles along their longitudinal edges.

FIG. 18A illustrates exemplary embodiments of interior or exterior architectural coverings with variable sculptural slat designs, wherein the sculptural slat designs have substantially different curvilinear, non-rectilinear profiles along their longitudinal edges.

FIG. 18B illustrates exemplary embodiments of exterior architectural coverings with variable sculptural slat designs, wherein the sculptural slat designs have substantially different curvilinear, non-rectilinear profiles along their longitudinal edges.

FIG. 18C illustrates exemplary embodiments of exterior architectural coverings with variable sculptural slat designs, wherein the sculptural slat designs have substantially different curvilinear, non-rectilinear profiles along their longitudinal edges.

FIG. 19A illustrates exemplary embodiments of interior furniture with variable sculptural slat designs, wherein the sculptural slat designs have substantially different curvilinear, non-rectilinear profiles along their longitudinal edges.

FIG. 19B illustrates exemplary embodiments of interior furniture with variable sculptural slat designs, wherein the sculptural slat designs have substantially different curvilinear, non-rectilinear profiles along their longitudinal edges.

FIG. 20 illustrates exemplary embodiments of grills and vents with variable sculptural slat designs, wherein the sculptural slat designs have substantially different curvilinear, non-rectilinear profiles along their longitudinal edges.

### DETAILED DESCRIPTION

The present disclosure relates to sculptural slats, wherein varying orientations of sculptural slats within a sculptural slat structure may provide a range of one or both decorative or ambient variable impact. For example, sculptural slats may provide transitional states for a window covering, wherein if the covering is in an open position, the sculptural slat structure may present a first set of characteristics, and wherein the set of characteristics may change as the orientation of the sculptural slats is adjusted.

In some aspects, the present disclosure provides variations on potential designs, smart technology integration, and applications to other types of slattable objects, including, for example, exterior and interior window coverings, architectural panels, dividers, and screens; furniture; and automobiles components. Aftermarket solutions to upgrade traditional slatted structures and slattable objects are described, along with manufacturing methods to create customized sculptural slats and sculptural slat structures based on preferences, installation requirements, and slattable object. In the following sections, detailed descriptions of examples and methods of the disclosure will be given.

The description of both preferred and alternative examples, though thorough, are exemplary only, and it is understood that to those skilled in the art that variations, modifications, and alterations may be apparent. It is therefore to be understood that the examples do not limit the broadness of the aspects of the underlying disclosure as defined by the claims.

### GLOSSARY

Ambient Variable: as used herein, refers to an ambient characteristic that a sculptural slat and sculptural slat structure may affect. In some aspects, an ambient variable impact relates to the extent of the effect. In some implementations, ambient variables may include light, shadow, visual privacy, temperature, sound, air flow, moisture, or a combination.

Clear Zone: as used herein, refers to a non-sculpted core portion of a sculptural slat, wherein the clear zone may define the base functional parameters of a sculptural slat. In some embodiments, slattable object integration features may be located within the clear zone, wherein a slattable object integration mechanism may connect to the slattable object integration features and join the sculptural slat to the slattable object. In some aspects, such as where there may be limited or symmetrical dimensions along two axes, clear zone boundaries may comprise an edge opposite to the sculptural edge up to a parallel edge before the extension of the sculptural edge. In some embodiments, such as where there may be substantial or asymmetrical dimensions along a third axis, the clear zone may comprise an interior portion of the sculptural slat.

Orientation: as used herein, refers to a transition state for a series of sculptural slats comprising a plurality of orientations. In some cases, transition occurs based on a physical change, such as opening, closing, or moving in some direction. In some aspects, the transition between orientations may occur through environmental or ambient qualities or external stimuli, which may, for example, cause a difference in the passage of light and shadow from exterior to the interior. For example, the position of a sculptural slat may be static, wherein the angle of a light source may affect how the slat design interacts or how it functions. By way of further example, a sculptural slat may control the passage of light, casting of shadows, or visual privacy that directly correlates to the sculptural profile of the sculptural slat performing these functions. A sculptural slat may also function differently based on the temperature outside without physically moving, based on external stimulus that may, for example, cause the sculptural slat to provide more shade. In some aspects, a change in the orientation may cause the sculptural slat to provide cooling in the second environment by providing more shade or heating in the second environment by providing more light.

Planar Sheet: as used herein, refers to a base shape for a sculptural slat, wherein a sculptural edge may provide detailing to at least one edge of the planar sheet. In some aspects, planar sheet may refer to multiple layers that may be combined to create a planar sheet. In some embodiments, a planar sheet may be manufactured through additive or subtractive manufacturing. In some implementations, a planar sheet may comprise a curved, angled, or irregular surface.

Sculptural slat: as used herein, refers to individual slats comprising one or more decorative characteristics and ambient variable impact, wherein at least one of those characteristics may be transitional based on the orientation of the sculptural slats within a sculptural slat structure. In some embodiments, those characteristics may control the ambient variable impact on one or both the first environment and the second environment. In some aspects, the ambient variable impact may be transitional, such as based on orientation of the sculptural slat, material of the sculptural slat, functional position of the sculptural slat, position of light sources in the environments, color of light sources, or intensity of the light sources, as non-limiting examples. For example, decorative characteristics may include color, shape, design, pattern, material, or size. For example, ambient variable impact may include light absorption, heat absorption, light reflection, shading, glow brightness, room darkening, sound dampening or amplification, air flow, temperature control, visual privacy, protection from dust, dirt, and particles. Sculptural slats may be arranged in a series, wherein a plurality of sculptural slats may combine, overlap, or fit into or onto each other to form a sculptural slat structure. In some embodiments, sculptural slats may be arranged in parallel layers within the sculptural slat structure. In some aspects, sculptural slats may be customized to the preferences of a customer, installation space, ambient variable impact, or other criteria.

Sculptural slat structure: as used herein, refers to a system of sculptural slats. In some aspects, a sculptural slat structure may comprise a traditionally slatted object including, for example, a window covering, including blinds, shutters, and louvers. In some aspects, a sculptural slat structure may be a modular system of sculptural slats that may be adhered, inserted, mechanically fastened, clipped, or converted to a slattable object.

Slattable object: as used herein, refers to a framework in which a sculptural slat or sculptural slat structure may be inserted into, added, adhered to, or combined with, including, but not limited to, a window covering, including blinds, shutters, louvers, shades, and other similar coverings; grills; vents; wall panels; ceiling panels; furniture, including, but not limited to, baskets, drawers, benches, tables, cribs, bassinets, bookcases, cabinets, shelves, and other similar furniture; building or architectural elements, including, but not limited to, louver doors; outdoor objects, including, but not limited to, fences, gates, trellises, arbors, pergola, planter, or raised garden boxes, and other similar objects; automotive structures and/or accessories, including, but not limited to, air conditioning vents, grills, and other similar structures and/or accessories; lap siding, panel siding, roof shingles, or other exterior cladding.

Slattable Object Integration Mechanism: as used herein, refers to a mechanism that may connect sculptural slats to a slattable object. In some aspects, a slattable object integration mechanism may be configured to manipulate the sculptural slats, such as to change orientation or to raise an entire sculptural slat structure. Examples of slattable object integration mechanism may include string ladders, bead chains, hooks, tilt bars, as non-limiting examples. In some aspects, the slattable object integration mechanism may be manual or automatic, such as driven by an electric motor.

Specification: as used herein, refers to any means of conveying a description of requirements, dimensions, materials, or other objective characteristics. In some aspects, the specification may include one or more drawing, three-dimensional visualization, physical samples, and textual description.

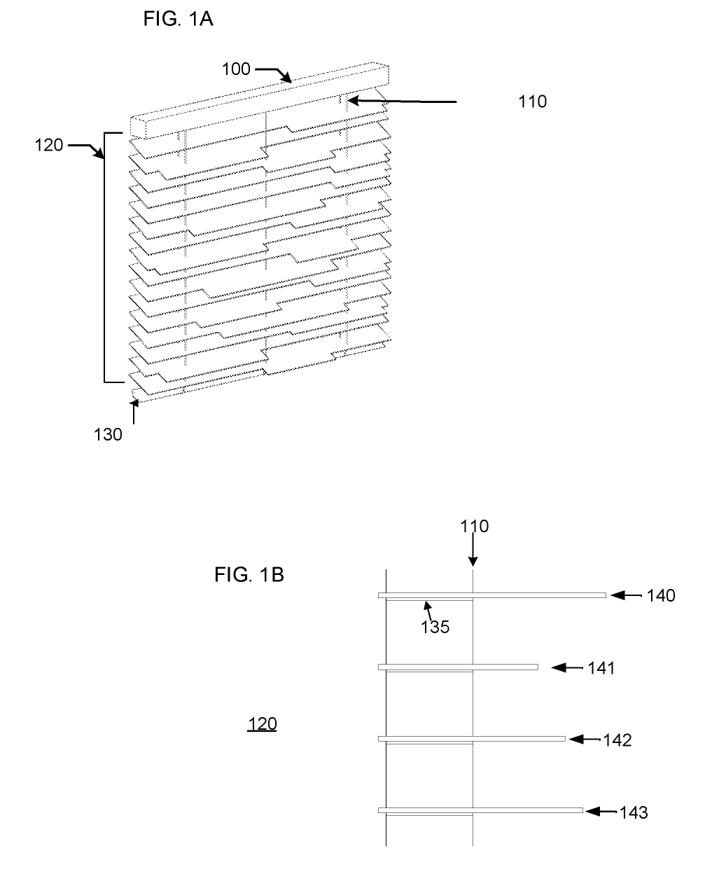

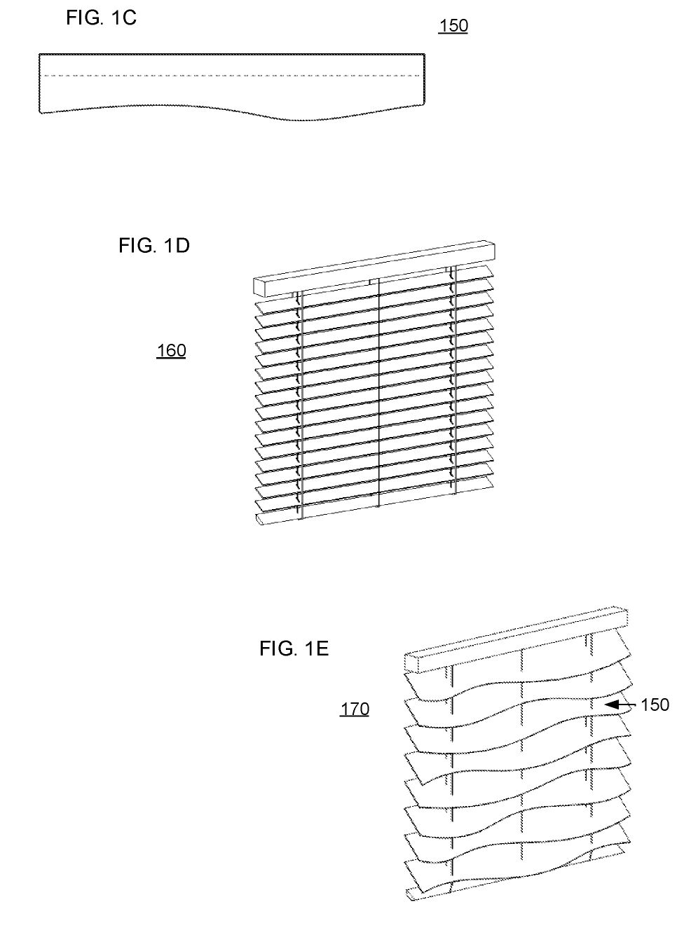

Referring now to FIG. 1A, exemplary sculptural slat structure containing a series of sculptural slats 120 is illustrated, wherein the sculptural slat structure may comprise a headrail 100, slattable object integration mechanism 110, a series of sculptural slats 120, and a bottomrail 130. In some aspects, a headrail 100 and bottomrail 130 may include, but not limited to, installation, support, and/or hold-down brackets, clips, plug sets, or a combination thereof. The specific mechanisms in the headrail 100 and bottomrail 130 may depend on one or both the functionality or design of the horizontal blind. In some aspects, the slattable object integration mechanism 110 may comprise a string ladder with lift cords.

In some embodiments, a series of sculptural slats 120 may include a pattern designed wherein the series of sculptural slats 120 may comprise a plurality of unique variations that may be installed in a pattern. In some embodiments, variations may be randomized, wherein a pattern may not be immediately obvious. In some implementations, a single sculptural slat within a series of sculptural slats 120 may consist of one extended layer. In some aspects, a single sculptural slat within a series of sculptural slats 120 may be composed of multiple layers stacked on top of each other. For example, a single sculptural slat may have one extended structural layer and one decorative layer attached on top. Another implementation may include a single sculptural slat with one extended structural layer and multiple decorative layers attached on top. Another implementation may include multiple decorative layers over multiple sculptural layers.

In some embodiments, a series of sculptural slats 120 may consist of, but not limited to, polyvinyl chloride (PVC), plastic, aluminum, vinyl, wood, paperboard, paper, metal, felt, fabric, medium-density fibreboard (MDF), oriented strand board (OSB), ceramic tile, porcelain tile, fiber cement, asphalt, clay tile, polyester, concrete, glass, foam, cork, melamine, or a combination thereof In some aspects, a series of sculptural slats 120 may be separately colored and/or stained along the front, back, in patterns, along thin edges, and/or in the interior or exterior of the material, wherein an interior of a material may be the same or different color or stain compared to the exterior. In some embodiments, there may be a color contrast between a pattern and main body of a sculptural slat.

In some implementations, a series of sculptural slats 120 may include colored edges. In some aspects, a single sculptural slat within a series of sculptural slats 120 may be composed of more than one material or color. In some implementations, a single sculptural slat may be composed of one material, though there may be sculptural slats with different materials and/or colors within a series of sculptural slats 120.

In some aspects, a series of sculptural slats 120 may interact with a tilt wand, tilt cord, or motorized tilt mechanism (not shown), to transition between orientations. In some implementations, a series of sculptural slats 120 may be manipulated by physical interaction to transition between orientations. In some aspects, a series of sculptural slats 120 may interact with a lift cord (not shown) to change its horizontal positioning. In some implementations, a series of sculptural slats 120 may interact with a cord equalizer (not shown) if needed. In some aspects, a series of sculptural slats 120 may interact with a one touch or cordless wandless system to change position and transition between orientations.

In some embodiments, the variable orientations may present transitioning views of the series of sculptural slats 120, wherein the transitioning views may comprise a range of one or both ornamental or ambient variable impact. In some aspects, the transitioning views may present different perspectives of the sculptural slats 120, wherein the variable orientations may present a unique overall appearance at each orientation. For example, the ornamental characteristics may be one or more color, perceived geometry, or patterns. In some implementations, the transitioning views may present different ambient variable impact at each orientation. For example, the ambient variable impact may be one or more of light absorption, heat absorption, light reflection, glow brightness, shading, room darkening, sound dampening or amplification, air flow, temperature control, visual privacy, protection from dust, dirt, and particles, or other similar functionality according to some embodiments of the present disclosure.

As an illustrative example, at variable orientations, a series of sculptural slats 120 may present a range of perceived geometry and provide a range of light absorption. At a first orientation, such as a completely open orientation, the light absorption may be at a minimum, and the perceived geometry may be a series of jagged lines. At a second orientation, such as a completely closed, upward orientation, the light absorption may be at a maximum for the series of sculptural slats 120, and the perceived geometry may be comparable to a mountain range.

As another illustrative example, at variable orientations, a series of sculptural slats 120 may present a range of colors and provide a range of heat absorption. At a first orientation, such as a completely closed, upward orientation, the heat absorption may be at a maximum for the series of sculptural slats 120, and the color may be a deep purple to indicate that orientation may provide the coolest setting. At a second orientation, such as a completely open orientation, the heat absorption may be at a minimum, and the color may be a vibrant red to indicate the warmest setting. At a third orientation, such as a completely closed, downward orientation, the heat absorption may be somewhere in between the minimum and maximum heat absorption, and the color may be a light blue to indicate a moderate position within the range of heat absorption.

In some aspects, a series of sculptural slats 120 may interact with a device (not shown) to transition between orientations. In some aspects, a series of sculptural slats 120 may interact with a smart device (not shown) to transition between orientations. The smart device may include an application that controls certain aspects of a series of sculptural slats 120, including, but not limited to, remotely accessing sculptural slat functionality, changing orientation remotely, changing appearance of one or more sculptural slats in the series of sculptural slats 120, setting when a series of sculptural slats 120 change orientation, interacting with weather information in the cloud or with a smart device to adjust accordingly, and the like. In some aspects, a series of sculptural slats 120 may interact with the environment itself, changing depending on either pre-programmed or user programmed settings, such as changing orientation depending on outdoor or indoor temperature, exposure to sunlight, or based on user behavior or prior use.

In some embodiments, a series of sculptural slats 120 may be responsive to the functionality or use of where it is placed, and may adjust according to a change depending on the use. In some implementations, a series of sculptural slats 120 may appear different depending on the opacity of the material it is comprised of, further altering its appearance depending on its orientation. For example, a series of sculptural slats 120 may alter its appearance, or be set to do so, if a particular location is used for work, play, or a general living space.

Referring now to FIG. 1B, an exemplary cross-sectional side view of sculptural slat structure with a series of sculptural slats 120 is illustrated, wherein the sculptural slat structure may comprise a series of sculptural slats 120, a slattable object integration mechanism 110, and a sculptural slat support 135. A series of sculptural slats 120 may further be comprised of individual sculptural slats 140-143 composed of one or multiple layers.

In some embodiments, a series of individual sculptural slats 120 may rest on a sculptural slat support 135. In some implementations, one or more individual sculptural slats 140-143 may extend beyond the slattable object integration mechanism 110 and sculptural slat support 135. In some aspects, individual sculptural slats 140-143 may be of variable shapes, designs, widths, depths, segments, and layers.

As described in FIG. 1A, a series of sculptural slats 120 may include repeated variations of individual or unique slat designs. In some implementations, variations may be randomized, wherein a pattern may not be immediately obvious. In some implementations, a single sculptural slat 140 within a series of sculptural slats 120 may be made of one extended layer. In some aspects, a single sculptural slat within a series of sculptural slats 120 may be composed of multiple stacked layers, which may be assembled and stabilized utilizing a range of connective mechanisms. For example, a single sculptural slat may have one extended structural to layer and one decorative layer attached on top. Another implementation may include a single sculptural slat with one extended structural layer and multiple decorative layers attached on top.

As described in FIG. 1A, in some embodiments, a series of sculptural slats 120 may consist of, but not limited to, polyvinyl chloride (PVC), plastic, aluminum, vinyl, wood, paperboard, paper, metal, felt, fabric, medium-density fibreboard (MDF), oriented strand board (OSB), ceramic tile, porcelain tile, fiber cement, asphalt, clay tile, polyester, concrete, glass, foam, cork, melamine, or a combination thereof. In some aspects, a series of sculptural slats 120 may be separately colored and/or stained along the front, back, in patterns, along thin edges, and/or in the interior or exterior of the material, so that if an interior of a material is a different color or stain compared to the exterior, there may be a color contrast between a pattern and main body of a sculptural slat. In some implementations, a series of sculptural slats 120 may include colored edges. In some aspects, a single sculptural slat within a series of sculptural slats 120 may be composed of more than one material or color. In some implementations, a series of sculptural slats 120 may comprise single sculptural slats of varying material or colors, wherein each sculptural slat may comprise multiple materials or colors, or various sculptural slats within the series of sculptural slats 120 may comprise different materials or colors.

In some implementations, a series of individual sculptural slats 120 may layer shapes of material on top of a main sculptural slat body. In some aspects, two patterns may overlap in a multi-layer sculptural slat to create a new blended pattern. In some embodiments, three-dimensional sculptural slats may be created by bent sculptural slat edges. In some implementations, a sculptural slat 140-143 may comprise a range of thicknesses, which may be achieved, for example, by additive or subtractive methods.

In some embodiments, a sculptural slat support 135 may not have individual sculptural slats extended as shown in FIG. 1B. An after-market solution may be obtained to replicate the characteristics described in FIG. 1A. In such instances, a sculptural cover or sculptural slat extender may hold one or more layers that attach, adhere, affix, connect, couple, clip, bind, and/or latch, or some functional equivalent thereof, to existing products, to recreate the transitional functionality of the sculptural slats as described in FIG. 1A.

For example, with the addition, application, or installation of the after-market solution, one or both the decorative or ambient variable impact of a slattable object or standard or traditional slat system may adopt the decorative and ambient variable impact of the sculptural slat, wherein the characteristics may be adjusted through transitioning the series of sculptural slats 120 between orientations.

Referring now to FIG. 1C, an exemplary sculptural slat 150 is illustrated. Referring now to FIG. 1D, an exemplary slattable object 160 is illustrated. In some aspects, a slattable object 160 may comprise traditional slats, such as blinds or shades. In some embodiments, a slattable object 160 may comprise a sculptural piece that may not be associated with traditional slats, such as wall art. Referring now to FIG. 1E, an exemplary sculptural slat structure 170 is illustrated, wherein the sculptural slat structure 170 comprises a series of sculptural slats 150.

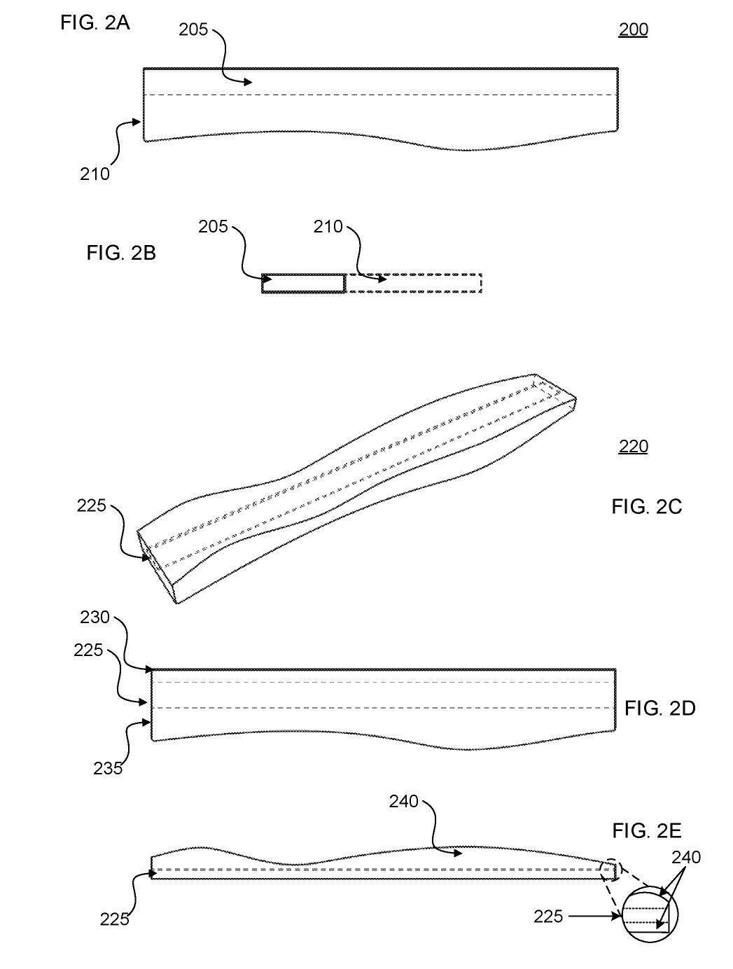

Referring now to FIG. 2A-2B, an exemplary sculptural slat 200 with a continuous surface is illustrated. In some aspects, a sculptural slat 200 may comprise a first functional zone 205 and a second functional zone 210, wherein the first functional zone 205 may comprise a core portion within the sculptural slat 200. In some embodiments, the first functional zone 205 may comprise a clear zone, and the second functional zone 210 may comprise the sculptural edge, wherein the sculptural edge may determine the ambient variable impact.

Referring now to FIG. 2C-2E, an exemplary sculptural slat 220 sculpted in two axes with variable surface 240 on a third axis is illustrated. In some implementations, a sculptural slat 220 may comprise a first functional zone 225 that may be a clear zone located in an internal portion of the sculptural slat 220, wherein the variable surface 240 may be located above or below the first functional zone 225. In some aspects, the sculptural slat 220 may comprise a second functional zone 235 and a third functional zone 230, wherein the first and second functional zones 230, 235 may provide an ambient variable impact. In some embodiments, the ambient variable and the ambient variable impact may be the same or different between the first and second functional zones 230, 235.

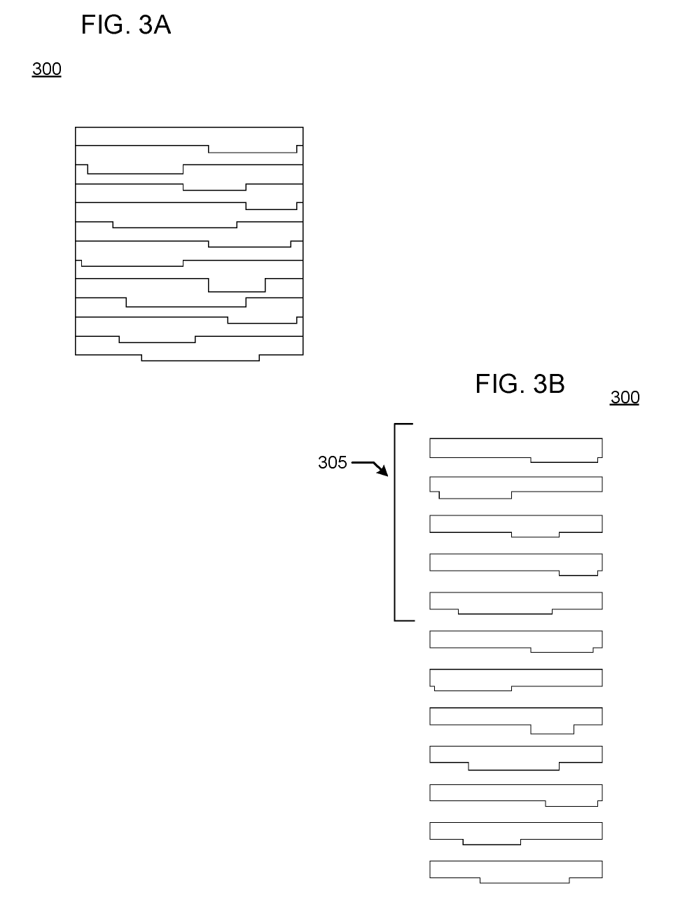

Referring now to FIGS. 3A and 3B, an exemplary series of variable sculptural slat designs 300 is illustrated, wherein the sculptural slat designs have substantially different orthogonal, non-rectilinear profiles along their longitudinal edges. FIG. 3A illustrates a closed grouping of the variable sculptural slat designs 300 from one exemplary orientation. FIG. 3B illustrates a separate grouping of the variable sculptural slat designs 300 to illustrate individual sculptural slats, wherein a pattern set 305 of sculptural slats may be repeated. These sculptural slat shapes may repeat throughout a series or they may vary throughout. These sculptural slat shapes may alter the appearance of the sculptural slat structure, or have different decorative characteristics, depending on its orientation. There is a potential for an extensive range of orientations and decorative characteristics utilizing permutations of degrees for perspective and a sculptural slat structure designs.

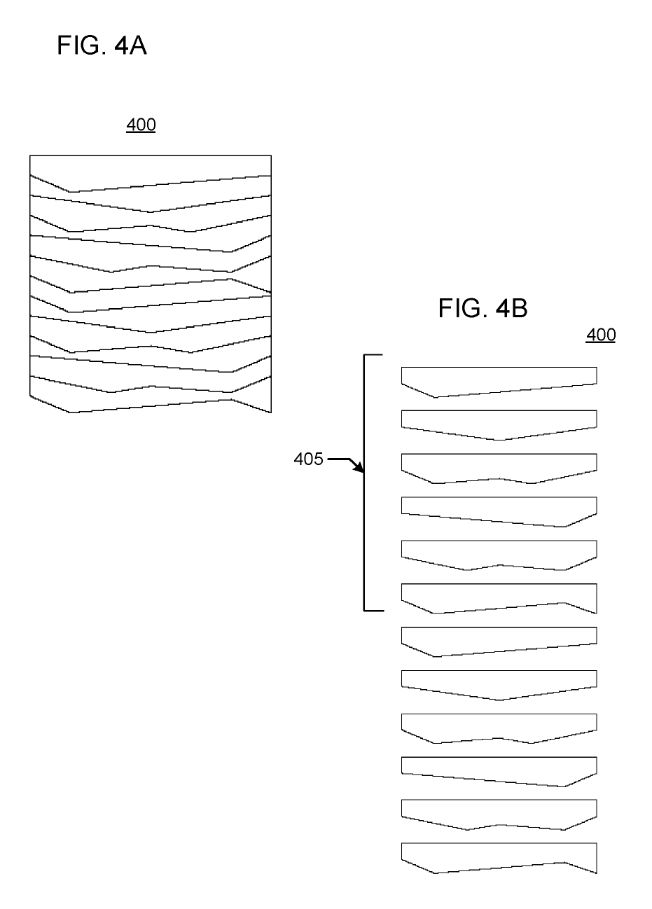

Referring now to FIGS. 4A and 4B, an exemplary series of variable sculptural slat designs 400 is illustrated, wherein the sculptural slat designs have substantially different angular, non-rectilinear profiles along their longitudinal edges. FIG. 4A illustrates a closed grouping of the variable sculptural slat designs 400 from one exemplary orientation. FIG. 4B illustrates a separate grouping of the variable sculptural slat designs 400 to illustrate individual sculptural slats, wherein a pattern set 405 of sculptural slats may be repeated. In some embodiments, FIGS. 4A and 4B may include a sculptural slat sub-series wherein sculptural slat shapes may repeat throughout the sculptural slat series.

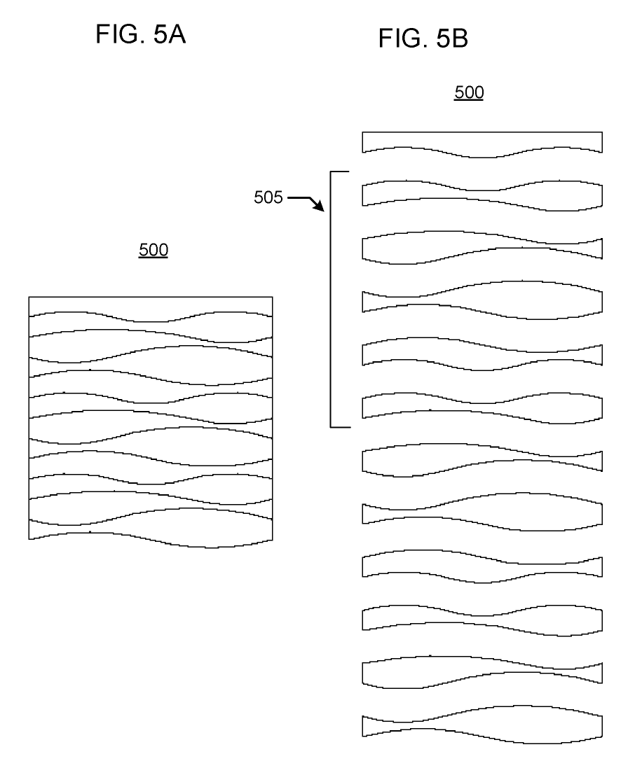

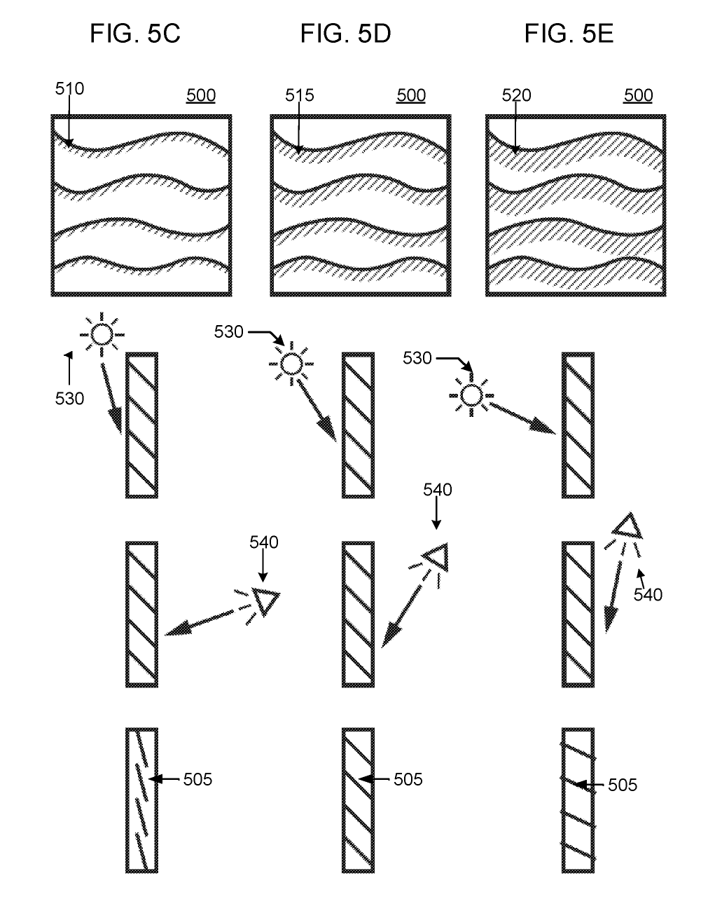

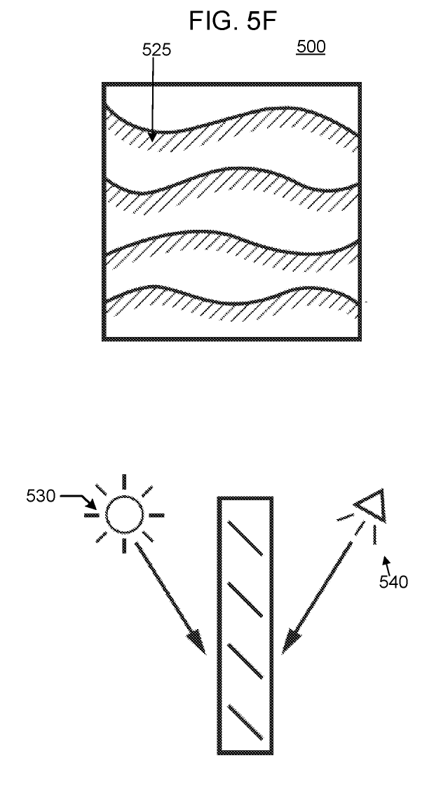

Referring now to FIGS. 5A and 5B, an exemplary series of variable sculptural slat designs 500 is illustrated, wherein the sculptural slat designs have substantially different curvilinear, non-rectilinear profiles along their longitudinal edges. FIG. 5A illustrates a closed grouping of the variable sculptural slat designs 500 from one exemplary orientation. FIG. 5B illustrates a separate grouping of the variable sculptural slat designs 500 to illustrate individual sculptural slats, which, for illustrative purposes have non-rectilinear profiles along one or both of their longitudinal edges. In some embodiments, FIGS. 5A and 5B may include a sculptural slat sub-series 501 wherein sculptural slat shapes may repeat throughout the sculptural slat series.

Referring now to FIGS. 5C-5F, an exemplary series of sculptural slats 500 with different ambient variable impact and associated conditions that may cause the ambient variable impact 510, 515, 520, 525 is illustrated. In some aspects, a series of sculptural slats 500 may be installed between an exterior and an interior, such as in front of an exterior window. In some aspects, the further away and lower down the light source is located behind the slats, the deeper the ambient variable impact appears on adjacent slats and surfaces. In some embodiments, the closer and higher up the light source is located behind the slats, the shallower the ambient variable impact appears on adjacent slats and surfaces. In some implementations, the further away and lower down the light source is located in front of the slats, the shallower the ambient variable impact appears on adjacent slats and surfaces. In some aspects, the closer and higher up the light source is located in front of the slats, the shallower the ambient variable impact appears on adjacent slats and surfaces, and the more open the rotational orientation of the slats within the sculptural slat structure, the deeper the ambient variable impact appears on adjacent slats and surfaces. The more closed the rotational orientation of the sculptural slats within the sculptural slat structure, the shallower the ambient variable impact appears on adjacent slats and surfaces.

Referring to FIG. 5C, a shallow ambient variable impact 510 may be caused where an external light source 530 may be located high in the sky, an internal light source 540 may be located almost perpendicular to the sculptural slat structure, or where the sculptural slats 505 may be angled in a closed position. Referring to FIG. 5D, a moderate ambient variable impact 515 may be caused where an external light source 530 may be located at a moderate position in the sky, such as around midday or midmorning; an internal light source 540 may be located at a more moderate angle to the sculptural slat structure, or where the sculptural slats 505 may be angled in a moderate position. Referring to FIG. 5E, a significant ambient variable impact 520 may be caused where an external light source 530 may be located low in the sky, an internal light source 540 may be located almost parallel to the sculptural slats, or where the sculptural slats 505 may be angled in an open position. Referring to FIG. 5F, a moderate ambient variable impact 525 may be caused where both an external light source 530 and an internal light source 540 may be located at similar positions relative to the sculptural slats. In some embodiments, there can be different light sources either in front of or behind the sculptural slats which generate different ambient variable impacts on the sculptural slat structures simultaneously. For example, a blue colored light source at dusk from a first environment may be absorbed by the areas of the sculptural slats closest to the first environment. A yellow colored light source from electric light inside may be absorbed by the areas of the sculptural slats closest to the second environment. Shadows will be cast differently on areas of the sculptural slats depending on the position and angle of the light sources in the first and second environments. In some aspects, the ambient variable impact may also include, as non-limiting examples, sound, temperature control.

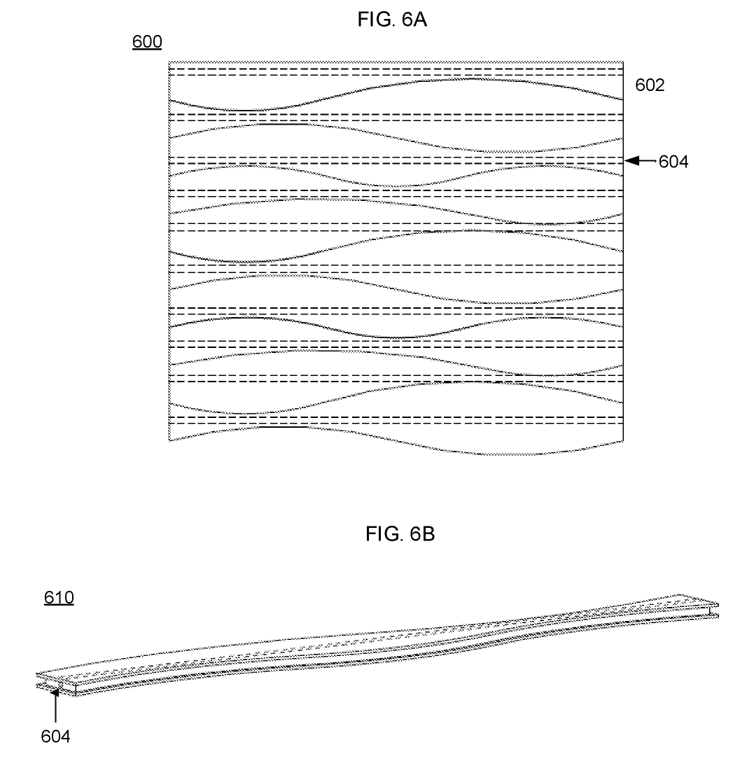

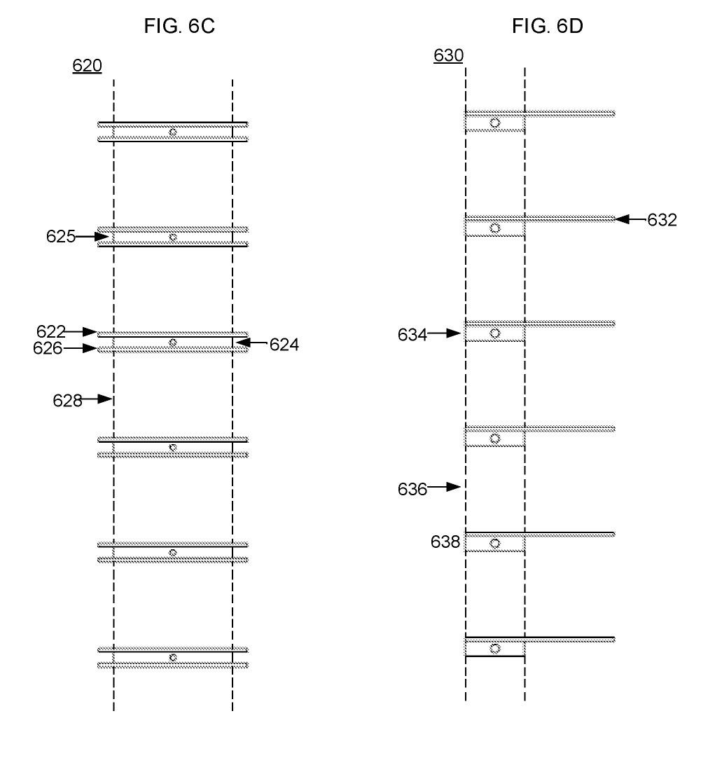

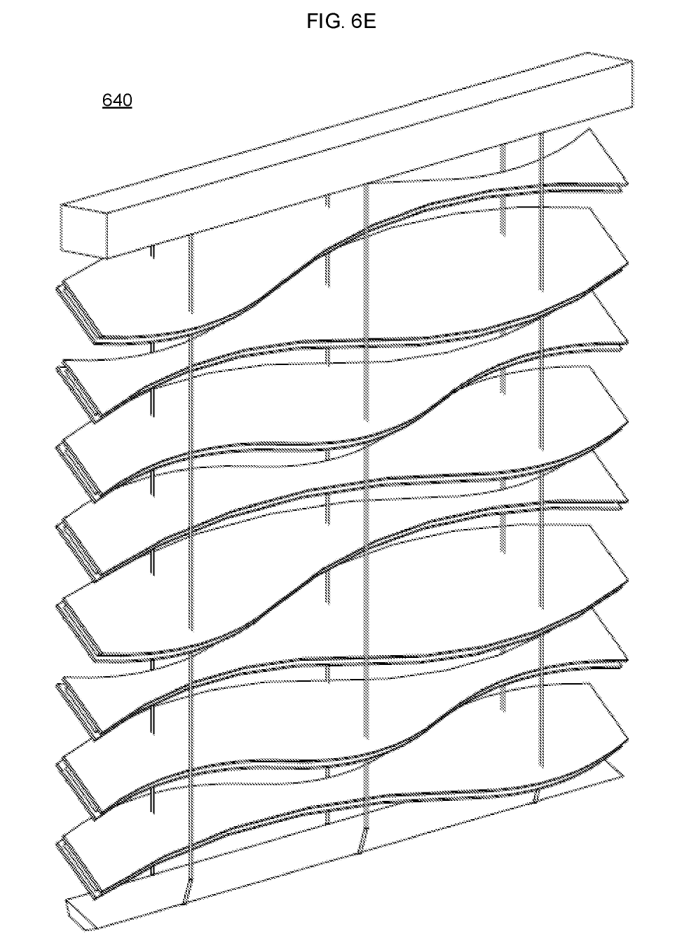

Referring now to FIGS. 6A and 6B, an exemplary series of variable sculptural slat designs 600 is illustrated, wherein a sculptural slat 602 may have a light source inside a sculptural slat, slattable object, or sculptural slat structure that creates an illuminated sculptural feature. FIG. 6A illustrates an exemplary sculptural slat structure of variable sculptural slat designs 600 with backlighting from one exemplary orientation. FIG. 6B illustrates an exemplary isometric view of a sculptural slat 610 incorporating a light-source 604. The sculptural slat 602 may be connected to or incorporate a light source 604 that may connect to another sculptural slat, creating a chain of sculptural slats 602 and light sources 604 to create the illuminating display or functionality. In some aspects, the sculptural slat 602 itself may comprise the light source 604. In some implementations, a light source 604 may provide backlighting to the sculptural slat 602 or the closed grouping of variable sculptural slat designs within a sculptural slat structure 600. A light-source 604 may be attached to a power source, which may be internal, such as a battery or solar powered, or external, such as through a cable or plug.

In some embodiments, the sculptural slats 602 may be coated with phosphorescent material to be able to radiate visible light after being energized, either by natural or artificial light. This may be coupled with a light source 604 to either increase or vary the intensity of light emitted from the sculptural slat. A variety of phosphorescent elements may be used to create “glowing” functionality, which may depend on the persistence and/or color of light sought. For example, a sculptural slat 602 may be coated with strontium aluminate or zinc sulfide to provide longer bursts of illumination when there is no lighting. In some aspects, the phosphor may be mixed into a sculptural slat 602 and molded within it.

In some implementations, a user may be able to control the lighting functionality through various control inputs, such as through a smart device, wall mounted controls, on the sculptural slat structures themselves, or by some other means. In some embodiments, light sources 604 may be interchangeable, transitional, programmable, or extractable to provide a variety of different lighting options. In some aspects, where a light source 604 may be embedded in the sculptural slat structure 600 itself, or the sculptural slat structure 600 hosts the light source 604, the sculptural slat 602 may be customized or removable to create custom designs and/or light patterns.

Light sources 604 may include a variety of luminescent materials, including, but not limited to, light-emitting diodes, fluorescents, organic light-emitting diodes, polymer light-emitting diodes, active-matrix organic light-emitting diode, phosphorescent materials, and ultraviolet materials. Liquid crystals may be used to filter or control one or both color and light sources. Materials listed may be combined to create different coloring, luminescent, or display effects.

As an illustrative example, the sculptural slat 602 may be coated in liquid crystal, and the light source 604 may comprise light-emitting diodes, wherein the light-emitting diodes may emit a range of colors. The orientation of the liquid crystal coating may be controlled separately to adjust the perceived brightness of the light-emitting diode.

Referring now to FIGS. 6C and 6D, side views of exemplary sculptural slats are illustrated indicating exemplary configurations as to how sculptural slats with a light-source may connect to one another, such as being placed between two sculptural slat layers 620 or being connected to an individual sculptural slat layer 630. This chain then continues throughout the series of sculptural slats demonstrated in FIG. 6A. FIG. 6C illustrates a side view of an exemplary series of sculptural slats 620 wherein a sculptural slat 622 connects to a light source 624 which then connects to another sculptural slat 626, comprising a dual sculptural slat and light source unit 625, which then connects to another set by some slattable object integration mechanism 628. FIG. 6D illustrates a side view of an exemplary series of sculptural slats 630 wherein a sculptural slat 632 connects to a light source 634, comprising a sculptural slat and light source unit 638, which then connects to another set by some slattable object integration mechanism 636. The slattable object integration mechanism may comprise a string ladder, stacked sculptural slats, or other methods of connecting a series of sculptural slats 620. In some aspects, the slattable object integration mechanism may connect a primary power source to the light sources within the series of sculptural slats.

Referring now to FIG. 6E, an exemplary sculptural slat structure containing a series of sculptural slats wherein a sculptural slat may have a light source that creates a glowing feature or provides an illuminated sculptural slat is illustrated. In some aspects, the illumination of the sculptural slats may be independently controlled. As an illustrative example, the illumination of two of the sculptural slats may be off, four of the sculptural slats may be illuminated in a static color, and for the remaining two, the illumination may cycle through a range of colors.

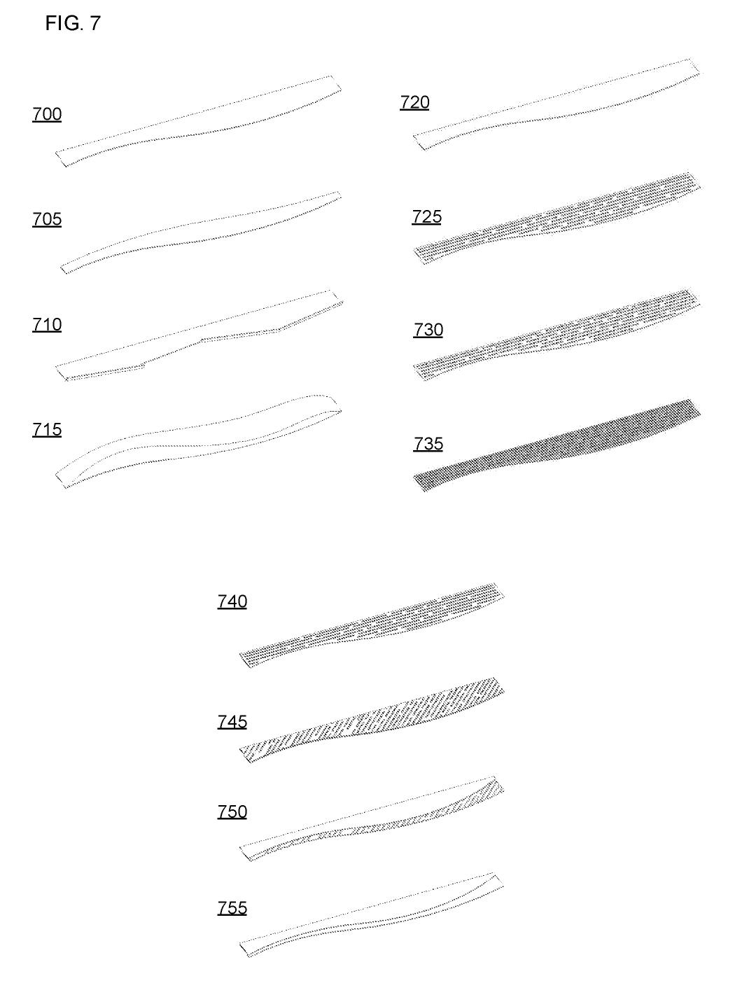

Referring now to FIG. 7, an exemplary series of variable sculptural slat designs is illustrated, including a slat with one longitudinal edge with a non-rectilinear profile 700, a slat with two longitudinal edges with a non-rectilinear profile 705, a slat with bent edges 710, a slat with variable thickness 715 by additive or subtractive manufacturing methods, a solid color slat with no pattern 720, a slat with a cut pattern 725, a slat with a scored pattern 730, a slat with color contrast with a scored pattern 735, a single layer slat with a cut pattern 740, a multiple layered slat with cut patterns combined to create a new blended pattern 745, a combined solid sculptural layer with a cut pattern 750, a slat with combined multiple layers of solid sculptural slats 755.

In some aspects, these sculptural slat variations may be mixed and matched to create different sculptural slat designs, wherein the base sculptural slat element was the same. In some embodiments, different sculptural slat designs may facilitate different ambient variable impact, such as controlling how much light comes through or how light appears through each sculptural slat. For example, one sculptural slat design may represent a three-dimensional sculptural slat for decorative characteristics while another sculptural slat design 730 may control how much light comes through. For ambient variable impact, these design variations may be combined to control a variety of functional and decorative characteristics in the sculptural slats.

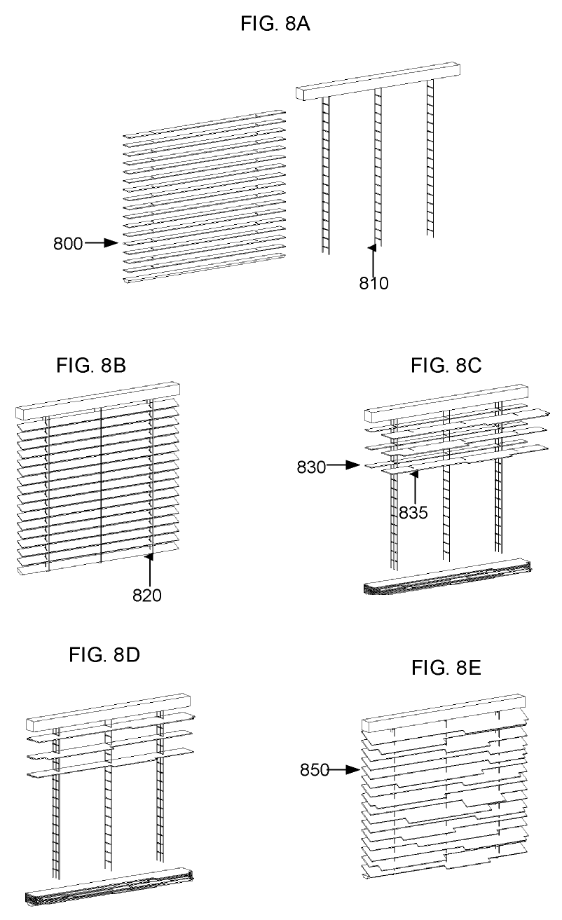

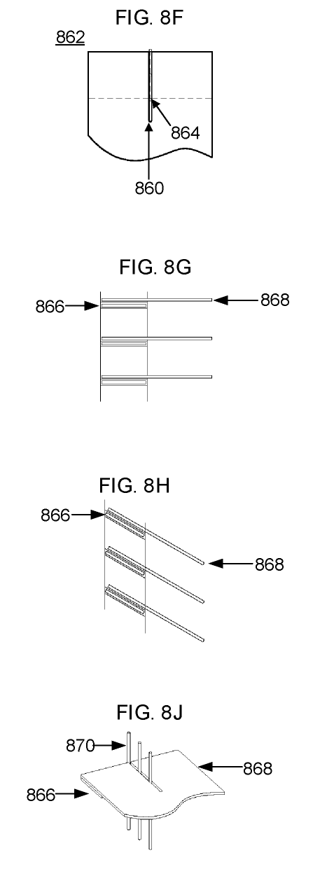

Referring now to FIGS. 8A-8E, exemplary method steps of assembling multi-layered distinctive sculptural slat composites using conventional blinds and a slattable object integration mechanism is illustrated. FIG. 8A illustrates a bottom layer of a sculptural slat composite 800 being prepared to slide horizontally along the length of a sculptural slat through a string ladder rung 810. FIG. 8B illustrates how pull cords of a string ladder 820 may be slid vertically through slattable object integration feature in the bottom layer of a sculptural slat composite 800. FIG. 8C illustrates a top layer of a sculptural slat composite 830 whose corresponding slattable object integration feature 835 can align with a corresponding string ladder 820 so that the a slattable object integration mechanism may be inserted into the slattable object integration features they align with. FIG. 8D illustrates a top layer of a sculptural slat composite 830 that may be aligned directly above a bottom layer of a sculptural slat composite 800 so that the two layers may be attached together with a string ladder 820 rung between the bottom layer of a sculptural slat composite 800 and top layer of a sculptural slat composite 830. FIG. 8E illustrates a series of sculptural slats 850 that may rotate in unison with a string ladder rung 810 through various transitional states, ranging between open-to-view and closed-to-view positions.

In some embodiments, there may be different ways to convert traditional or conventional slats to the multi-layered sculptural slats described herein. Different methods of customization, assembly, and processing may include, but are not limited to, scissors, laser cutters, 3D printers, CNC machines, additive and subtractive methods, stamping, casting, routing, screen prints, paints, stains, and other methods of manufacture. This may depend on the material used in the construction of the sculptural slat, or the adhesive to be used for modifying the traditional or conventional slat. For example, different materials may include those described and illustrated in FIG. 1. These materials may necessitate different forms of adhesion to be viable for affixing the multi-layered sculptural slat aspect.

For example, adhesion mechanisms may include, but are not limited to, glues, welding, chemical bonding, magnetics, hook and loop fasteners, adhesive tapes, snap on, clip on, mechanical fastening, latching, hooks, embedding, snapping, inserting, sliding, clicking, folding, and other connective techniques. An effective adhesion mechanism may depend on the materials and the manufacturing techniques for the sculptural slats. For example, magnetic adhesion mechanisms may be appropriate where the materials may include metallic components. Magnetic adhesion may provide a temporary adhesion mechanism, which may be useful for one or both modular embodiments and post-manufacture embodiments where a consumer may install or assemble the sculptural slats. Where a more permanent adhesion method may be preferable, glues or heat welding may be effective, such as where the materials may comprise plastics or metals. In some aspects, a wrap alternative may be sold as an after-market solution to offer similar functionality as described herein. In some embodiments, a sculptural wrap may fit into, fold over, combine with, embed with, or adhere to a standard blind to create the multi-layered sculptural slats described herein.

In some implementations, there may be variations on sculptural slat articulation, which may include variations on score pattern, cut pattern, color pattern, layer shapes, layer patterns, contour, bend, and sculpted thickness. In some aspects, variations may depend on color, materials, or orientation. In some embodiments, the positioning of slattable object integration features may depend on the functionality of the sculptural slats, which may include a variety of uses, such as, but not limited to, blinds, shutters, louvers, vertical blinds, wall panels, ceiling clouds, vents, screens, furniture, baskets, drawers, doors, gates, pergolas, trellises, or fences.

Referring now to FIGS. 8F-8J, a multi-layered sculptural slat joint 860 within a sculptural slat composite 862 can envelop a slattable object integration mechanism 864 between a bottom layer 866 and a top layer 868 and sit within a slattable object integration mechanism 870. In some implementations, a bottom layer 866 of a sculptural slat composite may be inserted horizontally through the clear opening dimensions of the slattable object integration mechanism 864 so that the multiple strings of a rung may loop around the bottom layer. In some aspects, a bottom layer 866 of a sculptural slat composite may rest on top of each string ladder rung 864. In some implementations, a multi-layered sculptural slat joint 860 may comprise a slattable object integration feature to align with each slattable object integration mechanism so that a slattable object integration mechanism may be inserted into the top layer 868 in a direction perpendicular to the sculptural slat's length. In some aspects, once a top layer 868 is directly above the bottom layer 866, the two layers may be attached to one another with a slattable object integration mechanism 864 fitting in between. In some embodiments, when the bottom layer 866 and a top layer 868 are attached together, a sculptural slat composite 862 may rotate in unison with or without a slattable object integration mechanism 870 between various transitional states, ranging from open-to-view to closed-to-view positioning. In some aspects, the slattable object integration feature may extend through the slat slicing the sculptural slat into segments that connect together in a multi-layered slattable object integration feature. This slattable object integration feature connects to the slattable object integration mechanism to attach or rotate the sculptural slat within a sculptural slat structure.

In some implementations, a middle layer may be used to stabilize a string ladder or to provide further support to either the bottom or top layer. In some aspects, a middle layer may be inserted horizontally into a slattable object integration mechanism with a bottom layer to then attach to a slattable object integration mechanism together. In some embodiments, a top layer may then attach to the bottom and middle layer once it is directly above the bottom and middle layers and aligns with each slattable object integration mechanism so that each slattable object integration mechanism may be inserted into the top layer in a direction perpendicular to a sculptural slat's length. In some implementations, a bottom, middle, and top sculptural slat layer may attach together, wherein this sculptural slat composite may rotate in unison with or without a slattable object integration mechanism between various transitional states, ranging from open-to-view to closed-to-view positioning while resisting the overturning forces exerted on the top layer.

In some embodiments, a joint that may attach a slattable object integration mechanism to a sculptural slat creates structural support for the depth of the sculptural slat that cantilevers beyond the vertical supports of the slattable object integration mechanism, with the depth being larger than all the clear open dimensions of a string ladder. In some aspects, when the sculptural slat is supported by the slattable object integration mechanism rung below, it may create a joint that allows a blinds assembly to move in unison, which resists overturning forces as the sculptural slat properly rotates between various states of transition, from open-to-view to closed-to-view positions.

In some implementations, a joint may comprise a slot cut in a sculptural slat through which a slattable object integration mechanism may be inserted. In some aspects, once aligned with a corresponding rung of a string ladder, a sculptural slat may be shifted to one side so that multiple strings of a slattable object integration mechanism may loop around a sculptural slat with at least one string on top and at least one string on the bottom of a sculptural slat. In some aspects, a loop binds a sculptural slat to the slattable object integration mechanism so that it may counteract the overturning forces exerted on a sculptural slat as it rotates between various transitional states, including, but not limited to, open-to-view to closed-to-view positions.

In some embodiments, a bottom layer may host a joint that is comprised of a slot through which a slattable object integration mechanism may be inserted. In some aspects, a sculptural slat may be shifted to one side that multiple strings of a slattable object integration mechanism may loop around a multi-layered joint with at least one string on top and at least on a string on the bottom of the layer once aligned with a corresponding rung of a slattable object integration mechanism. In some implementations, a top layer of this sculptural slat composite has a slot aligning with each slattable object integration mechanism so that a slattable object integration mechanism may be inserted into a top layer in a direction perpendicular to a sculptural slat's length. In some aspects, once a top layer is directly above a bottom layer, the two layers may be attached together with a slattable object integration mechanism between them. In some embodiments, when sculptural slat layers are attached together, a sculptural slat composite may rotate in unison with a slattable object integration mechanism between various transitional states, from open-to-view to closed-to-view positions, while resisting overturning forces exerted on the top layer.

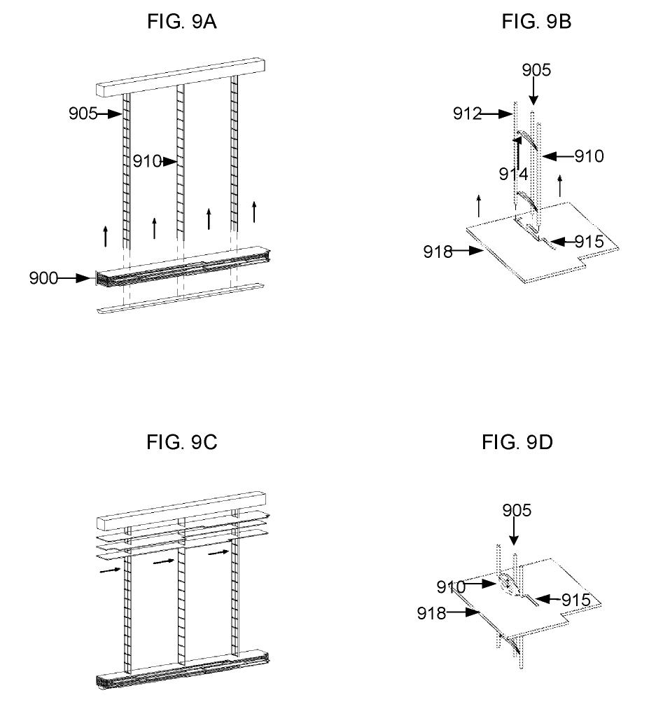

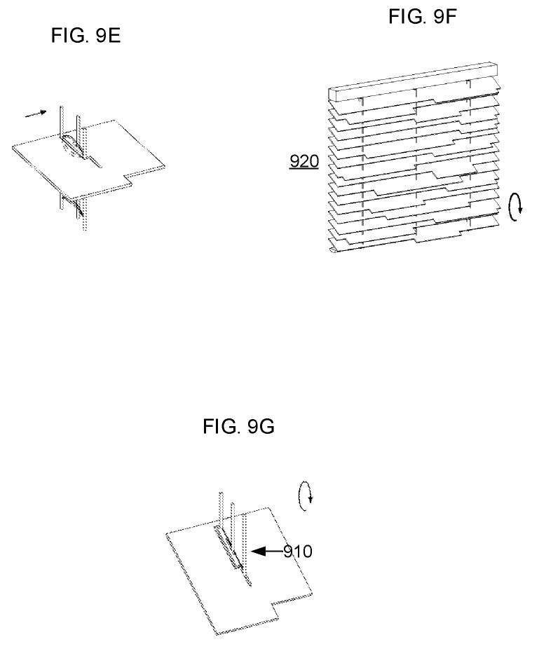

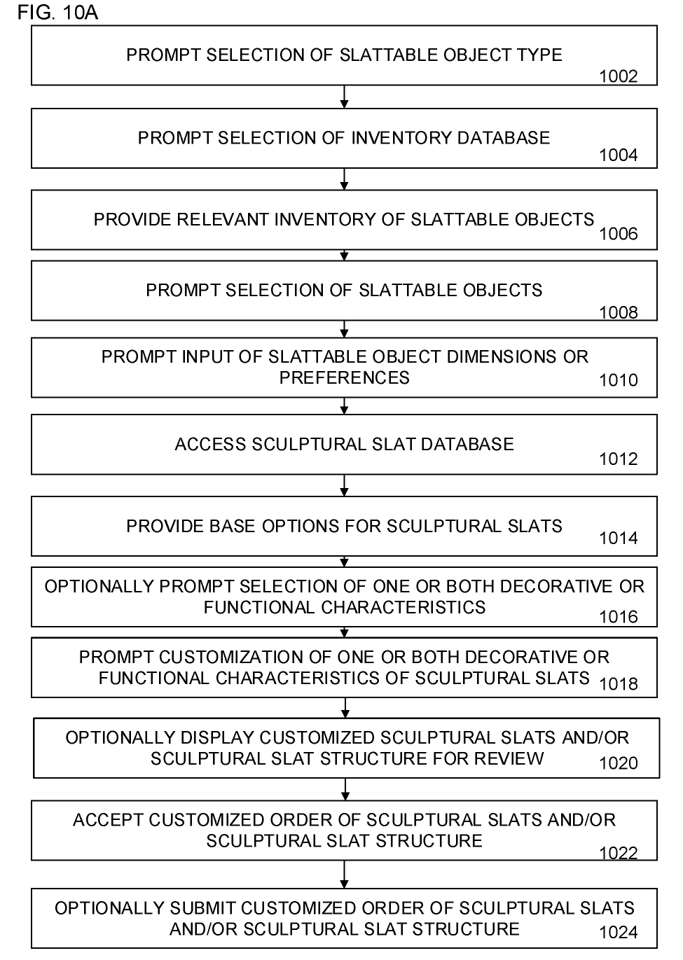

Referring now to FIGS. 9A-9G, exemplary method steps for sculptural slat structure assembly wherein a sculptural slat depth may be greater than the clear dimensions of a slattable object integration mechanism are illustrated. In some aspects, the slattable object integration mechanism may comprise string ladder. Referring now to FIGS. 9A and 9B, exemplary method steps for sculptural slat assembly is illustrated, wherein a bundle of sculptural slats 900, with each sculptural slat 918 comprising a sculptural slat joint 915, may be prepared through which a slattable object integration mechanism 905 can be slid vertically and a slattable object integration mechanism 910 may be slid horizontally.

Referring now to FIGS. 9C-9E, exemplary method steps for sculptural slat assembly is illustrated, wherein a bundle of sculptural slats 900, with each sculptural slat 918 comprising a sculptural slat joint 915, are prepared to be slid vertically through a slattable object integration mechanism 905 and horizontally through slattable object integration mechanism rung 910. In some embodiments, a sculptural slat 918 may be raised to align with a corresponding slattable object integration mechanism rung 910. In some implementations, a horizontal rung of the slattable object integration mechanism 905 may be spread apart to create a loop that may wrap around a sculptural slat joint 915. In some aspects, a vertical support 912 and horizontal rung of the slattable object integration mechanism 905 may be slid horizontally so that a horizontal rung of the slattable object integration mechanism 905 may loop around a sculptural slat 918 and a vertical support 912 may move up and down freely through a slot joint 915 when a sculptural slat 918 is rotated. In some aspects, attaching a sculptural slat 918 in a slot joint 915 may structurally support the depth of a sculptural slat 918 that may extend beyond the vertical support 912 of a string ladder 905.

Referring now to FIGS. 9F-9G, exemplary method steps for sculptural slat structure assembly is illustrated, wherein a series of sculptural slats 920 may rotate in unison with slattable object integration mechanism rungs 910. In some implementations, a series of sculptural slats 920 may rotate in unison with a string ladder between various transitional states, from open-to-view to closed-to-view positions, while resisting overturning forces exerted on the top layer that extends beyond the structural support of the slattable object integration mechanism.

In some embodiments, a variety of counterbalances, controls, or frameworks may be used to ensure that sculptural slats may be properly used as a covering. In some aspects, this may include a version wherein a string ladder is not used. In some implementations, this may include a version where a device may be included to create uniformity amongst the multi-layered sculptural slats, such as, a bar that ensures that they rotate similarly or supports the sculptural slats within whatever framework they are placed. In some aspects, this may be a weight distributed within the multi-layered sculptural slats themselves. In some embodiments, this may be a hidden bar that increases stability but is not immediately apparent to a user. In some aspects, a sculptural slat may use different forms of adhesion to stay together and continue its functionality, such as those materials listed and described in FIGS. 8A-8E.

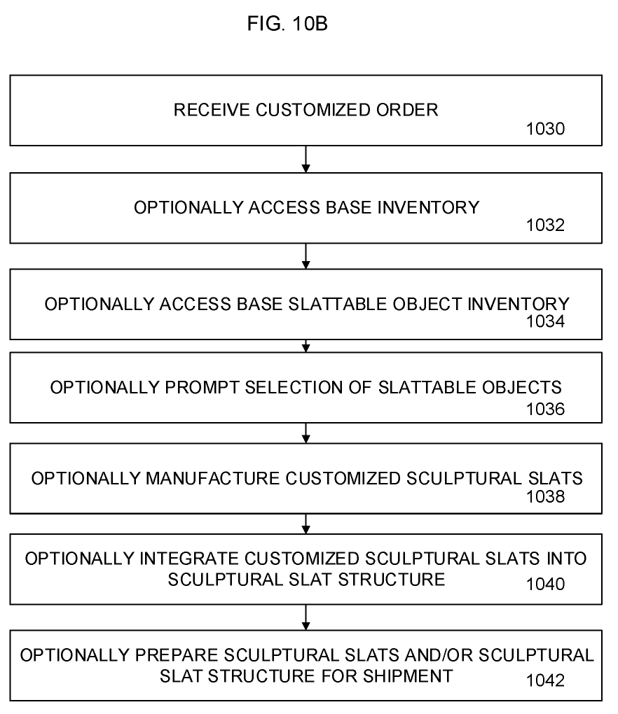

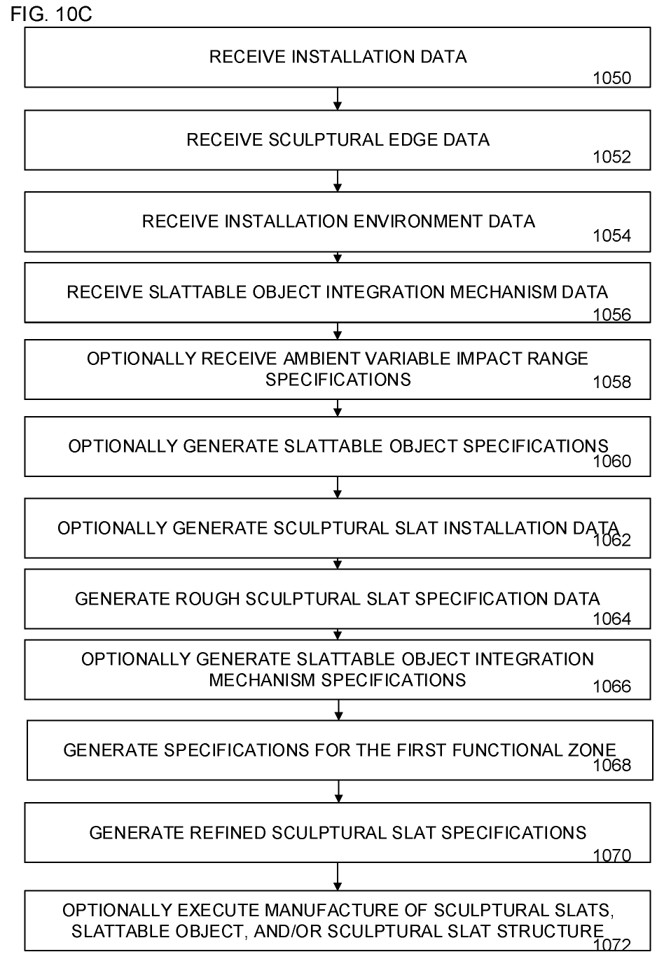

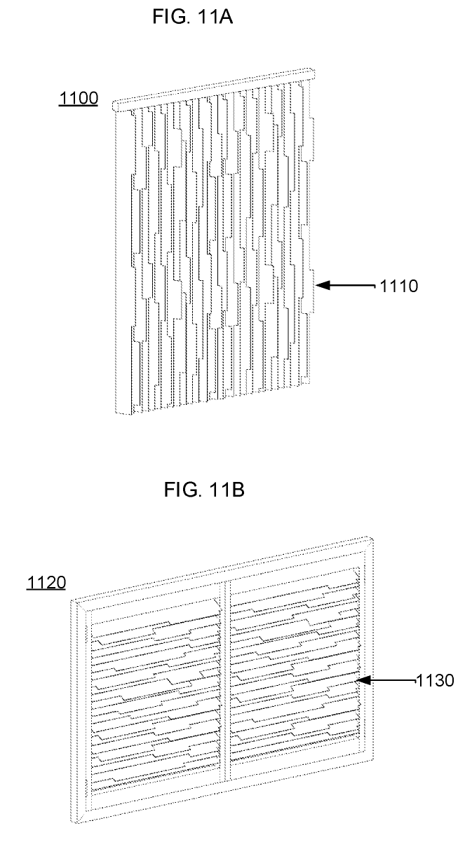

Referring now to FIG. 10A, an exemplary process flowchart for customizing and ordering sculptural slat structures is illustrated. At 1002, selection of a slattable object type may be prompted. At 1004, inventory database may be accessed. In some embodiments, at 1006, relevant base inventory may be accessed. At 1008, selection of a slattable object may be prompted. At 1010, an input for slattable dimensions or preferences may be prompted. At 1012, a sculptural slat database may be accessed. At 1014, pre-designed base options for sculptural slats may be provided. In some aspects, at 1016, a selection of one or both decorative or ambient variable impact may be prompted. At 1018, customization of one or both decorative or ambient variable impact of sculptural slats may be prompted. In some implementations, at 1020, a customized sculptural slat may be displayed using images, three-dimensional models, augmented reality, virtual reality, or some other means. At 1022, a customized order of sculptural slats may be accepted. In some embodiments, at 1024, a customized order of sculptural slats may be submitted. For example, the orders may be submitted to a manufacturer, installer, or local printer, such as a 3D printer, home printer, or retail printer.

Referring now to FIG. 10B, an exemplary process flowchart for manufacturing customized sculptural slats is illustrated. At 1030, a customized order may be received, such as from specifications submitted by a retailer, consumer, or other party. In some aspects, at 1032, a base inventory may be accessed, and, at 1034, a base slattable object may be selected. In some implementations, at 1036, a base slat may be selected, wherein the base slat may be modified by additive, subtractive, or adhesion techniques. At 1038, a customized sculptural slat may be manufactured, wherein the manufacturing may utilize raw or base materials, modifiable base slats, such as those selected at 1040, or combinations thereof. In some embodiments, at 1040, a customized sculptural slat may be integrated into a slattable object, such as those selected at 1034. For example, at 1040, customized sculptural slats may be integrated into a window covering, such as into interior shutters, creating a new sculptural slat structure. In some aspects, at 1042, the shipment of one or more sculptural slats or slattable objects may be prepared.

Referring now to FIG. 10C, an exemplary process flowchart for generating specifications for manufacturing customized sculptural slats is illustrated. At 1050, installation data may be received. In some aspects, installation data may comprise height data, width data, and depth data related to the installation site. At 1052, sculptural edge data may be received. At 1054, installation environment data may be received, such as related to a first and second environment, wherein the sculptural slat structure is configured to be installed between the first environment and the second environment. As an illustrative example, the first environment may be an exterior environment, and the second environment may be an interior environment, wherein the sculptural slat structure may be installed over a window that may separate the exterior and interior environment.

At 1056, slattable object integration mechanism data may be received. In some aspects, at 1058, ambient variable impact range specifications may be received, which may define a potential range of ambient variable impact based on one or more of the installation data, sculptural slat material, the installation environment data, and sculptural edge data, wherein the ambient variable impact range specifications at least partially define the slattable integration mechanism specifications and refined sculptural slat specifications. In some embodiments, at 1060, slattable object specifications may be generated, which may include, for example, a slattable object type, height data, depth data, and width data, wherein the slattable object specifications are based at least in part on one or more of the installation data, sculptural edge data, and generated rough sculptural slat specifications.

In some implementations, at 1062, sculptural slat installation data may be generated, such as, for example, a quantity of sculptural slats and alignment specifications defining at least installation distance between adjacent sculptural slats and installation distance between sculptural slats and the slattable object. At 1064, rough sculptural slat specification data may be generated, which may include, for example, sculptural slat width data and sculptural edge design. In some aspects, at 1066, slattable object integration mechanism specifications may be generated. At 1068, specifications for the first functional zone may be generated, which may include, for example, comprising slattable object integration feature specifications and alignment specifications, wherein alignment specifications define the first aligned edge, wherein adjacent sculptural slats are aligned at the first aligned edge when installed.

At 1070, refined sculptural slat specifications may be generated that may define augmentation of the first functional zone and the second functional zone, wherein the refined sculptural slat specifications are based at least in part on the at least one ambient variable, the slattable object integration mechanism, installation environment data, and the rough sculptural slat specification data. In some embodiments, at 1072, the manufacturing of one or more of the sculptural slat, the slattable object, the sculptural slat structure, or slattable object integration mechanism.

In some embodiments, a user accesses a database that generates available stock in real time. A user may access this database from smart devices, work stations, retail spaces, internet-connected devices, and/or devices connected to a server that generates real-time stock. From this database, a user may customize the overall shape of a sculptural slat structure, whether that be the design of the sculptural slat design or the structure itself, by manipulating the generated information either in real-time, through a series of options provided by a display or menu, or through a pre-programmed or pre-generated identification code. For example, an identification code may be generated at a retail location after a user looks at a display with samples, chooses how a sculptural slat structure should look, and then receives a print-out or follow-up notification, which may be by electronic means, to then revisit and order their design at a later time. A retail location may also ping a server to see whether they have any items currently in stock to accurately estimate availability.

In some implementations, a user may select from a set of default or pre-created sculptural slat structures with accompanying designs already in existence, or access a pool of content created by other users to see if a user also wants to order that creation. In some aspects, a user may upload a graphic to apply to a design that they may then order. In some embodiments, a user may create, customize, or choose from single-slat or multi-piece sculptural slat designs. In some implementations, a user may create, customize, or choose from silk screen or ink printed patterns. In some embodiments, a user may create, customize, or choose from cut, scored, or engraved patterns. In some aspects, a user may create, customize, or choose from colored edges to apply to a design. In some implementations, a user may apply a pattern to a sculptural slat structure, which they can create or customize, or choose from pre-existing patterns, such as dots, waves, diagonals, dunes or zigzags. In some embodiments, a user may order replacement sculptural slats for designs they previously ordered to replace a prior sculptural slat or to expand the functionality depending on the sculptural slat structure previously ordered.

In some embodiments, a user may create, customize, or choose from a variety of materials to apply to their sculptural slat structure creation. In some implementations, a database a user is accessing may advise the best combination or design based on the materials a user chooses from. In some implementations, a database a user is accessing may advise the best combination or design based on the patterns a user chooses from. In some implementations, a database a user is accessing may advise the best combination or design based on the sculptural shape a user chooses from. In some implementations, a database a user is accessing may advise the best combination or design based on the slatted object a user chooses from. In some aspects, a database may limit the choices a user may choose from based on their selections, such as if a metal would not pair with a certain color scheme due to unavailability or incompatibility.

In some implementations, a user may generate a digital visualization of their selection in real-time, using virtual or augmented reality to help the user display, design, and experience their selection. For example, a user may be at a retail location and choose a design for a sculptural slat structure. The design selected for the sculptural slat structure may then be digitally displayed, from either a kiosk within the retail location or from a portable device with access to that functionality, and have the designs digitally overlaid on physical models within the location. Separately, in some embodiments, this digital visualization can be displayed anywhere in a three-dimensional representation, wherein a user may appraise and investigate the design, functionality, shape, or pattern of the sculptural slat structure that they have chosen.

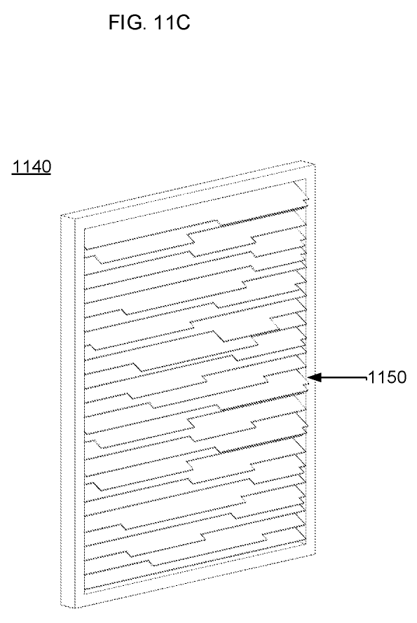

Referring now to FIGS. 11A-11C, exemplary embodiments of coverings that may use a series of sculptural slats are illustrated. Referring now to FIG. 11A, an exemplary vertical blind 1100 with a series of sculptural slats 1110 is illustrated. Referring now to FIG. 11B, an exemplary interior or exterior shutter 1120 with a series of sculptural slats 1130 is illustrated. Referring now to FIG. 11C, an exemplary louver 1140 with a series of sculptural slats 1150 is illustrated.

In some implementations, a series of sculptural slats may be used interchangeably within a design family. For example, a baseline sculptural slat can be pre-made or mass produced beforehand, then, these unfinished sculptural slats can be customized to fit within a variety of slatted objects or slatted structures with different sizes, colors, patterns, materials, or orientations, customized by the user. In some aspects, a series of sculptural slats may be mixed with other designs to create a new, mixed aesthetic, wherein the ambient variable impact of each sculptural slat may complement, augment, or parallel one another. For example, a sculptural slat made of certain material and design may be combined with a sculptural slat of a different material and design to affect lighting in the room. In some embodiments, sculptural slats may be altered or changed out depending on the functionality of the room.

For example, a room may be used for a work space during the day, but may be used for entertainment or recreational purposes at night. Changing the sculptural slats may change the ambiance of the room. Similarly, if each pair of sculptural slats is paired with predefined intelligent functionality, such as home or office settings, the smart sculptural slats may respond accordingly when the ambient variables are changed. For example, when a pair of sculptural slats are used for work purposes, a predefined amount of light may be let into the room, and when the sculptural slats are changed out for recreational purposes, they may interact with the ambient environment adjusting the temperature of the room and the amount of light to let in, based on one or more received specifications, learned preferences, or typical effective and comfortable levels. Similarly, the smart slats can be paired with a “wake-up” setting synced to a user's alarm clock to let light enter a room when it is time to wake up.

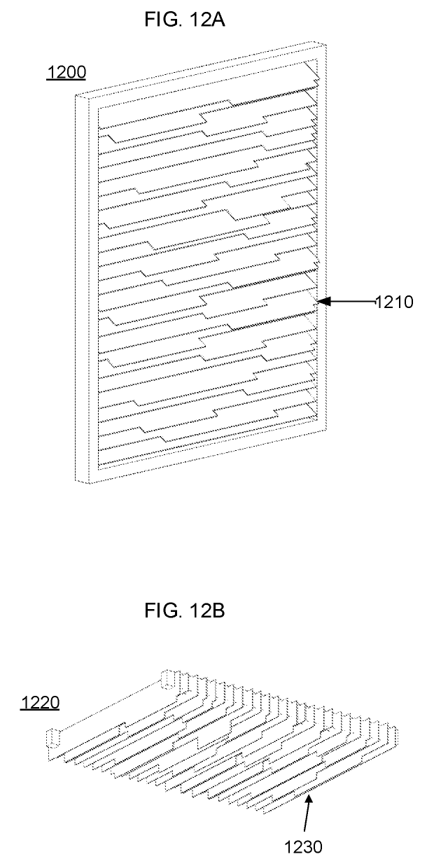

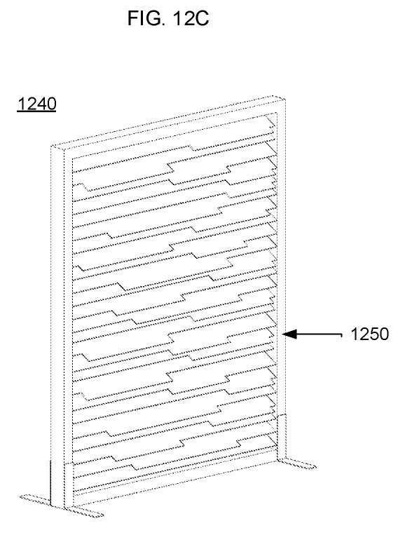

Referring now to FIGS. 12A-12C, exemplary embodiments of coverings relating to interior architecture that may integrate a series of sculptural slats are illustrated. Referring now to FIG. 12A, an exemplary wall panel 1200 with a series of sculptural slats 1210 is illustrated. Referring now to FIG. 12B, an exemplary ceiling cloud 1220 with a series of sculptural slats 1230 is illustrated. Referring now to FIG. 12C, an exemplary privacy screen 1240 with a series of sculptural slats 1250 is illustrated.

In some embodiments, orientation or placement of the sculptural slats may be used to affect acoustics within a room. For example, a wall panel may create a dampening or amplifying effect to either contain or expand sound within a room. In some implementations, sculptural slats may achieve a dampening effect with a material having acoustical properties, such as felt, located behind the slats or comprising the sculptural slats themselves. In some aspects, depending on how a wall panel is configured, it may direct the flow of sound within a room. In some implementations, sculptural slats may be combined for a different functionality. In some aspects, a sculptural slat may transition between orientations to provide different functionality, from controlling the flow of sounds within a room to the effect of sound within a room. In some embodiments, a family of coverings, such as a wall panel and a privacy screen, may interact with each other or amplify their functionality to further contribute to that aim, such as the acoustic control properties described herein. In some aspects, lighting may be integrated into a slattable object so that sculptural slights can manipulate the ambient variables of light, brightness, color, and intensity between a first environment behind the slats and a second environment in front of the slats.

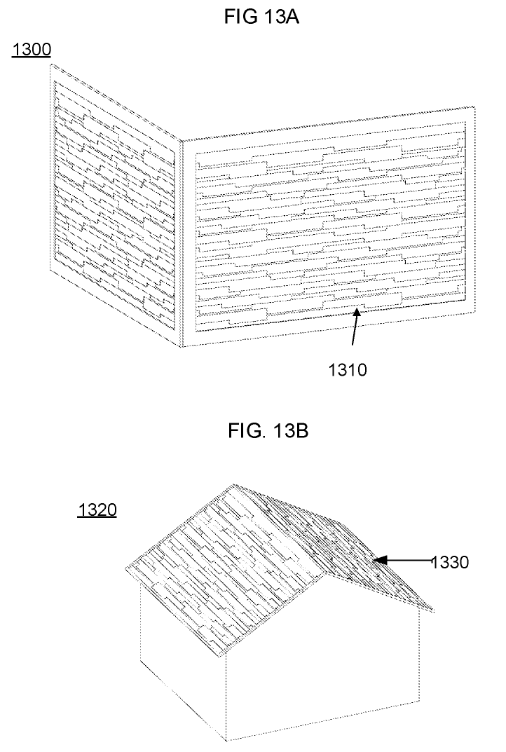

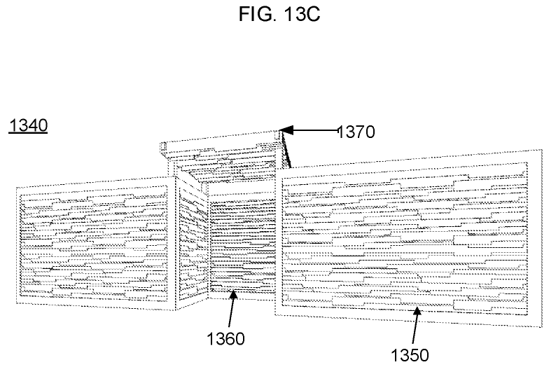

Referring now to FIGS. 13A-13C, exemplary embodiments of exterior architectural coverings that may use a series of sculptural slats are illustrated. Referring now to FIG. 13A, an exemplary lap siding 1300 with a series of sculptural slats 1310 is illustrated. Referring now to FIG. 13B, an exemplary set of roof shingles 1320 with a series of sculptural slats 1330 is illustrated. Referring now to FIG. 13C, an exemplary exterior installation sculptural slat structure 1340 is illustrated. In some embodiments, the exterior installation sculptural slat structure 1340 may comprise a fence 1350, a pergola 1370, and a gate 1360. In some aspects, alternate outdoor structures may include trellises, arbors, planter boxes, or raised garden boxes.

In some implementations, a sculptural slat may be coupled with other technology for ease of use. For example, a roof shingle may include sculptural slats with transitional functionality to expose solar paneling, or may incorporate solar paneling within the sculptural slats themselves, that may tilt or shift orientation to better absorb sunlight as it changes throughout the day. In some aspects, this may be done manually, through some means of user input, such as by some form of manipulation, control, or smart device, by pre-programmed means, or by adaptive technology that learns over time when to transition or rotate to best absorb sunlight. For example, the sun's hourly, daily, weekly, monthly, or annual path can be predicted and incorporated into the movement of the panels. In some implementations, a roof shingle with sculptural slats may be embedded within another covering so that insects or precipitation do not seep into a dwelling should the sculptural slats be in a rotated state. In some aspects, a roof shingle using sculptural slat technology may consist of clay tile, asphalt, plastic, fiberglass, or metal.

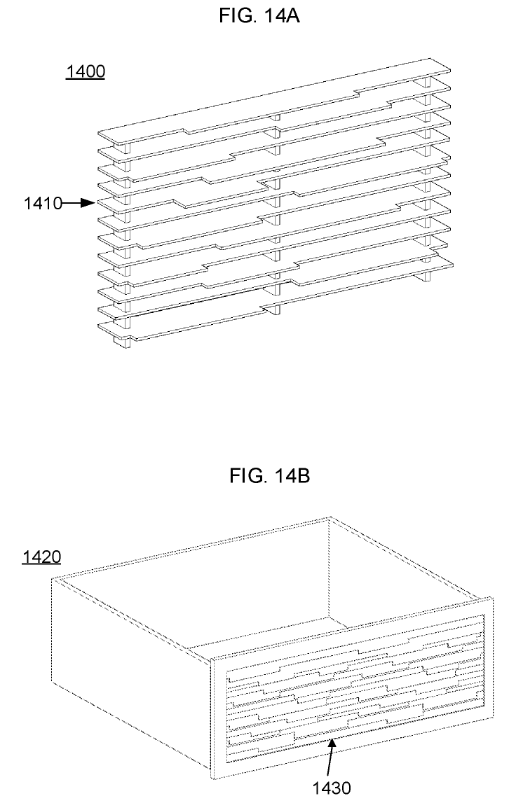

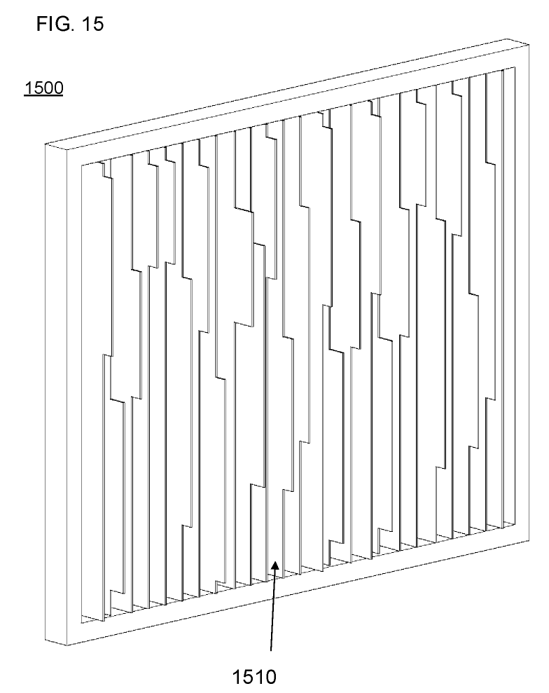

Referring now to FIGS. 14A and 14B, exemplary embodiments of interior furniture that may use a series of sculptural slats are illustrated. Referring now to FIG. 14A, an exemplary bookcase 1400 with a series of sculptural slat shelving 1410 is illustrated. Referring now to FIG. 14B, an exemplary drawer 1420 with a sculptural slat drawer front 1430 is illustrated.

In some embodiments, a sculptural slat may be used to scale privacy options. For example, a drawer with a set of sculptural slats may be manipulated so that the sculptural slats may reveal the contents of the drawer without having to slide the drawer open. This may make it more convenient should a user want to see the contents of a drawer without necessarily going through it, while ensuring that a user may reengage the privacy afforded by a covering should they not want others to see what is inside a drawer after they are done inspecting it. This functionality may also be used within the bookcase, where a sculptural slat shelf that is not being used can be manipulated to provide a covering over a shelf directly below or at some other location by fitting into the design through a variety of options, such as clicking in, sliding in, or being pushed in.

In some aspects, the sculptural slats themselves may be used to open and close the drawer, or a series of sculptural slats may be arranged in a way to resemble a handle to facilitate ease of use. In some implementations, sculptural slats may be removed or inserted should a user desire a different design or different functionality, such as removing convenience or privacy features. In the bookcase, sculptural slats may be removed or inserted per user preference to increase or decrease the size of the bookcase, including horizontally, diagonally, or vertically.

In some embodiments, alternate furniture may include baskets with sculptural slats, drawer fronts with louvered front, louver doors, sculptural slat benches, sculptural slat tables, sculptural slat tables with glass tops, crib sculptural slats, bassinet sculptural slats, and floating shelves.

Referring now to FIG. 15, an exemplary vent 1500 with a series of sculptural slats 1510 is illustrated. In some embodiments, FIG. 15 may illustrate a grill. In some implementations, a return and supply air conditioning vent and grill may have a series of sculptural slats. By extension, in some aspects, sculptural slats may be used for automotive uses, such as air conditioning vents or grill sculptural slats in front of a car. The transitional orientation of the sculptural slats may control the air flow, temperature, light, and shadow that pass through the slatted grill or vent in an architectural, mechanical, or automotive application.

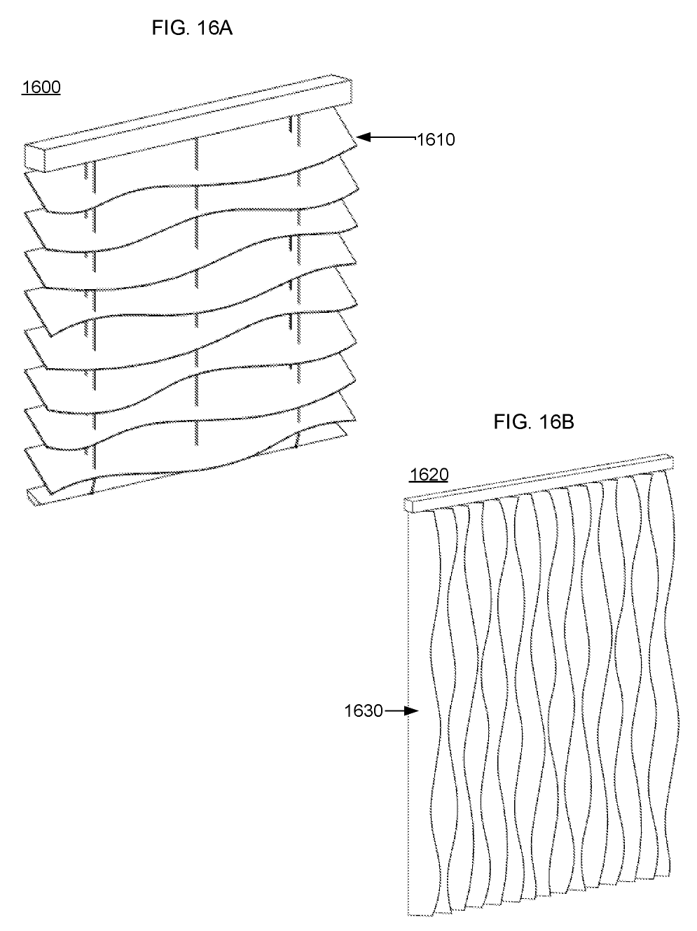

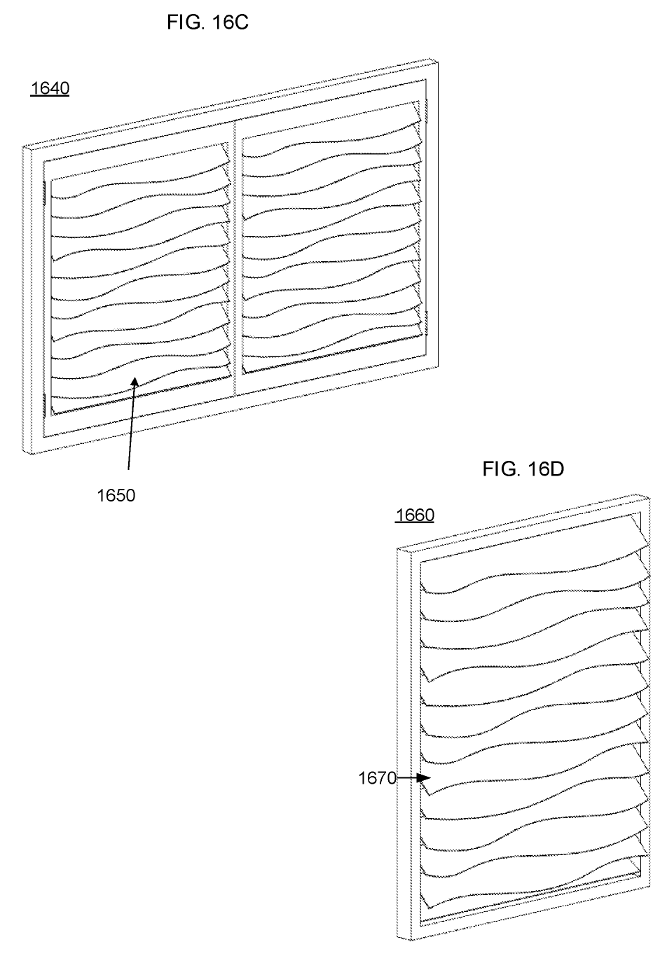

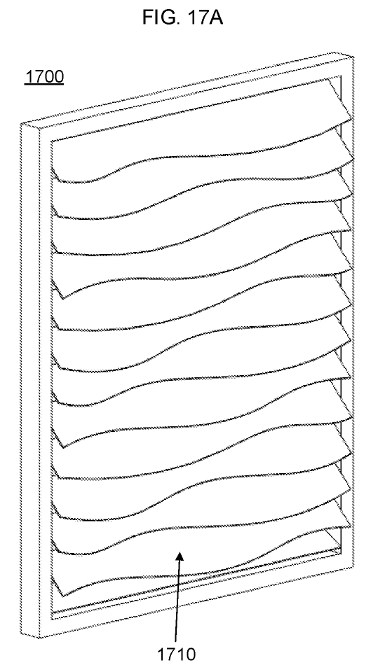

Referring now to FIGS. 16A-16D, exemplary embodiments of coverings that may use a series of sculptural slats are illustrated, wherein the series of sculptural slats have substantially different curvilinear, non-rectilinear profiles along their longitudinal edges.

Referring now to FIG. 16A, an exemplary horizontal blind 1600 with a series of curvilinear sculptural slats 1610 is illustrated. Referring now to FIG. 16B, an exemplary vertical blind 1620 with a series of curvilinear sculptural slats 1630 is illustrated. Referring now to FIG. 16C, an exemplary interior shutter 1640 with a series of curvilinear sculptural slats 1650 is illustrated. Referring now to FIG. 16D, an exemplary louver 1660 with a series of curvilinear sculptural slats 1670 is illustrated.

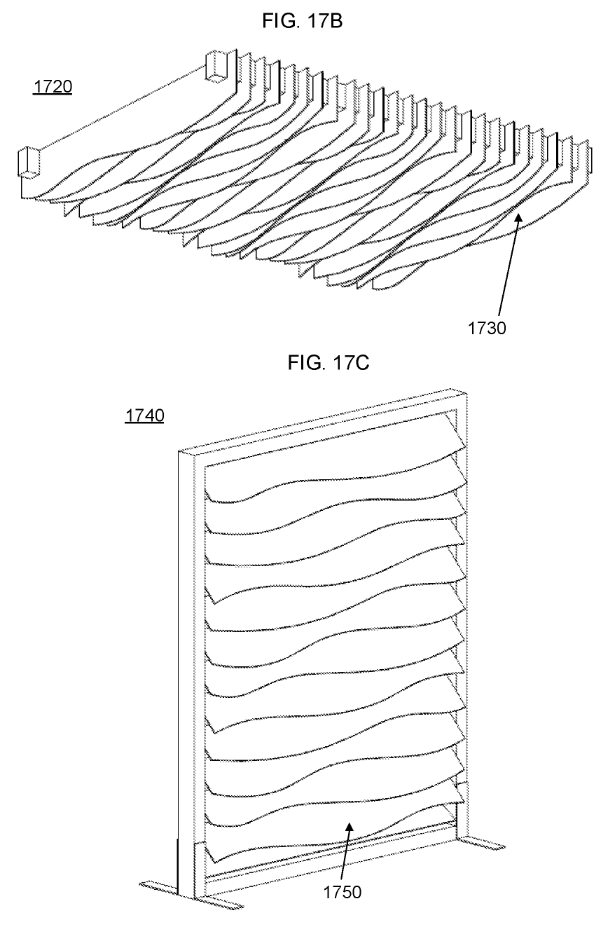

Referring now to FIGS. 17A-17C, exemplary embodiments of coverings relating to interior architecture with variable sculptural slat designs are illustrated, wherein the series of sculptural slats have substantially different curvilinear, non-rectilinear profiles along their longitudinal edges. Referring now to FIG. 17A, an exemplary wall panel 1700 with a series of curvilinear sculptural slats 1710 is illustrated. Referring now to FIG. 17B, an exemplary ceiling cloud 1720 with a series of curvilinear sculptural slats 1730 is illustrated. Referring now to FIG. 17C, an exemplary privacy screen 1750 with a series of curvilinear sculptural slats 1760 is illustrated. In some embodiments, interior architecture may have an illuminated sculptural feature integrated into the sculptural slat structures as described above in FIGS. 6A-6B.

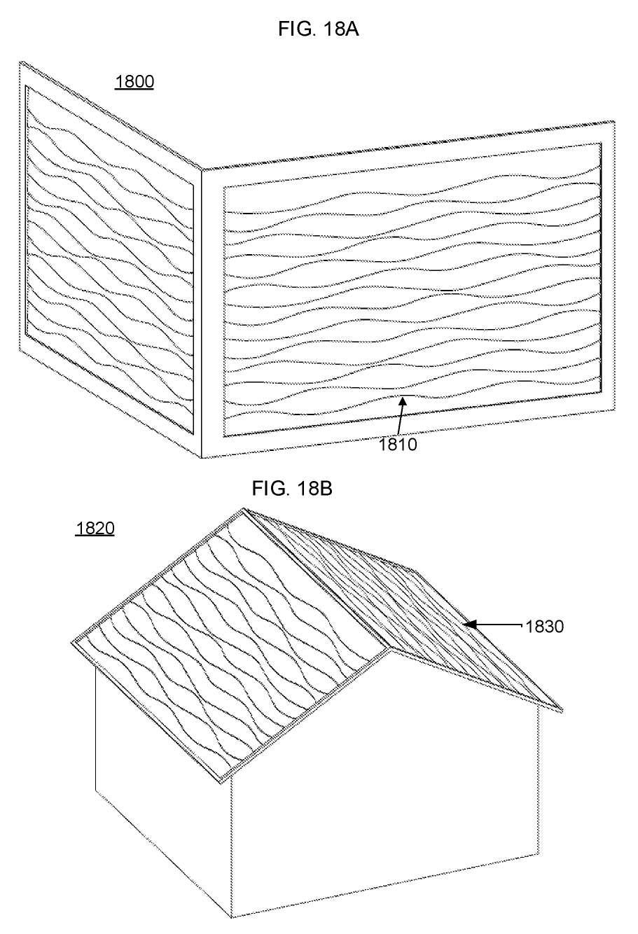

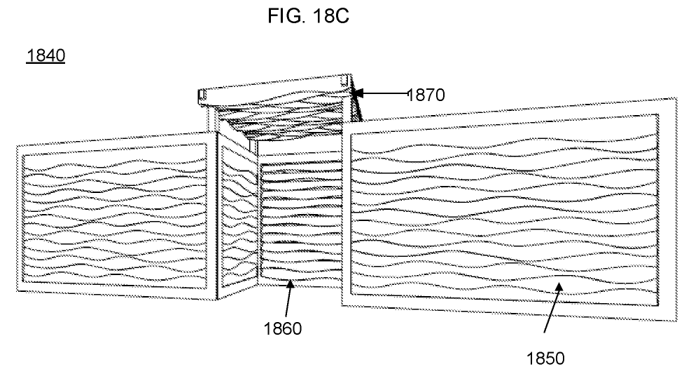

Referring now to FIGS. 18A-18C, exemplary embodiments of exterior architectural coverings that may use a series of sculptural slats are illustrated, wherein the series of sculptural slats have substantially different curvilinear, non-rectilinear profiles along their longitudinal edges. Referring now to FIG. 18A, an exemplary lap siding 1800 with a series of curvilinear sculptural slats 1810 is illustrated. Referring now to FIG. 18B, an exemplary set of roof shingles 1820 with a series of curvilinear sculptural slats 1830 is illustrated. Referring now to FIG. 18C, an exemplary exterior installation sculptural slat structure 1840 is illustrated. In some embodiments, the exterior installation sculptural slat structure 1840 may comprise a fence 1850, a pergola 1870, and a gate 1860. In some aspects, alternate outdoor structures may include walls, trellises, arbors, planter boxes, or raised garden boxes.

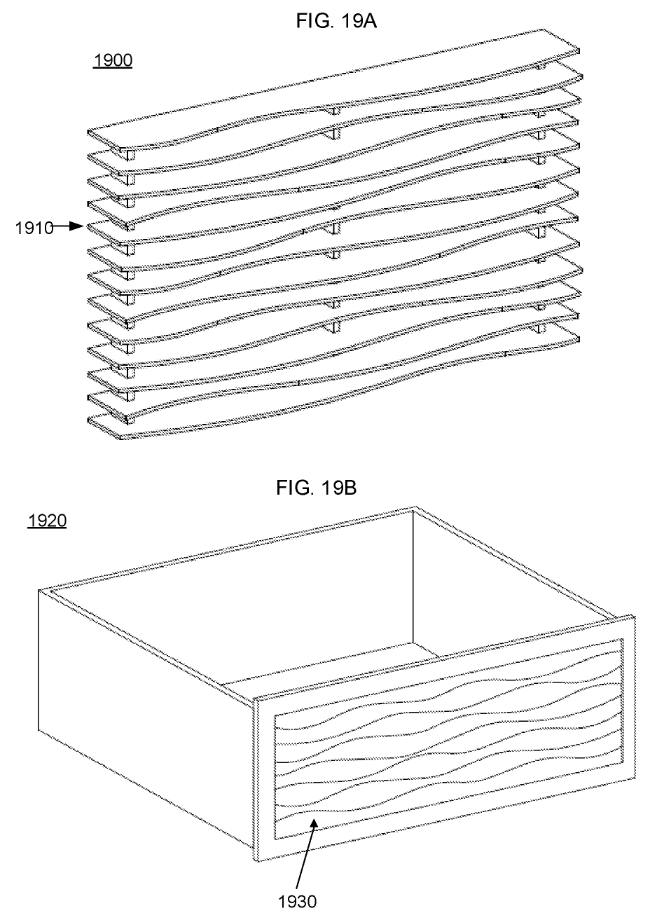

Referring now to FIGS. 19A-19B, exemplary embodiments of interior furniture that may use a series of sculptural slats are illustrated, wherein the series of sculptural slats have substantially different curvilinear, non-rectilinear profiles along their longitudinal edges. Referring now to FIGS. 19A, an exemplary bookcase 1900 with a series of curvilinear sculptural slat shelving 1910 is illustrated. Referring now to FIG. 19B, an exemplary drawer 1920 with a curvilinear sculptural slat drawer front 1930 is illustrated.

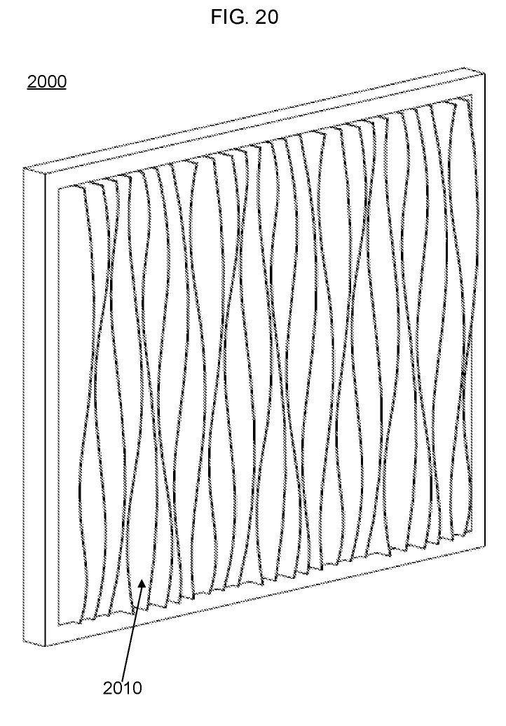

Referring now to FIG. 20, an exemplary vent 2000 with a series of curvilinear sculptural slats 2010 is illustrated. In some embodiments, FIG. 20 may illustrate a grill or vent panel for an airflow duct. In some aspects, the vent 2000 may comprise a section of exterior cladding, such as lap siding or panel siding.

### CONCLUSION

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A sculptural slat comprising:
a substantially planar sheet comprising four edges, wherein at least one of the four edges comprises a first sculptural edge, and wherein the substantially planar sheet comprises at least:
a first functional zone comprising a core portion of the sculptural slat and a slattable object integration feature, wherein the first functional zone is configured to control at least one ambient variable between a first environment and a second environment, and wherein a slattable object integration mechanism integrates into the slattable object integration feature when the sculptural slat is integrated into a slattable object; and
a second functional zone comprising a first sculptural portion extending from the core portion to the first sculptural edge, wherein the second functional zone is configured to cast a first sculptural shadow onto one or more adjacent sculptural slats and surfaces in the second environment.

2. The sculptural slat of claim 1, wherein the one or more ambient variable comprises at least a passage of light between the first environment and the second environment.

3. The sculptural slat of claim 1, wherein the one or more ambient variable comprises at least a temperature control between the first environment and the second environment.

4. The sculptural slat of claim 1, wherein the one or more ambient variable comprises at least visual privacy between the first environment and the second environment.

5. The sculptural slat of claim 1, wherein the first functional zone comprises a clear zone.

6. The sculptural slat of claim 1, wherein the sculptural slat is configured to fit over a non-sculptural slat.

7. The sculptural slat of claim 1, wherein the substantially planar sheet sculpted in two axes also comprises variable dimensions along a third axis, and wherein the core portion is located interior to the substantially planar sheet.

8. The sculptural slat of claim 1, further comprising a second sculptural edge opposite to the first sculptural edge, wherein the substantially planar sheet further comprises a third functional zone comprising a second sculptural portion extending from the core portion to the second sculptural edge, wherein the third functional zone is configured to cast a second sculptural shadow onto one or more adjacent sculptural slats and surfaces in the second environment.

9. A sculptural slat structure comprising:
a slattable object;
a plurality of sculptural slats inserted within the slattable object, wherein each of the plurality of sculptural slats comprises:
a substantially planar sheet comprising four edges, wherein at least one of the four edges comprises:
a first sculptural edge, and
a first aligned edge wherein the first aligned edge of each of the plurality of sculptural slats slats are aligned;
wherein the substantially planar sheet comprises at least:
a first functional zone comprising a core portion of the sculptural slat and a slattable object integration feature, wherein the first functional zone is configured to control at least one ambient variable between a first environment and a second environment; and
a second functional zone comprising a first sculptural portion extending from the core portion to the first sculptural edge, wherein the second functional zone is configured to cast a first sculptural shadow onto one or more adjacent sculptural slats and surfaces in the first or second environment; and
a slattable object integration mechanism connecting the plurality of sculptural slats to the slattable object, wherein the slattable object integration mechanism connects to the slattable object integration feature.

10. The sculptural slat structure of claim 9, wherein each of the plurality of sculptural slats are configured for a plurality of orientations within the slattable object.

11. The sculptural slat structure of claim 10, wherein the plurality of orientations are controllable through the slattable object integration mechanism.

12. The sculptural slat structure of claim 10, wherein the plurality of orientations creates a plurality of ambient variable impact.

13. The sculptural slat structure of claim 12, wherein the one or more ambient variables comprises at least a passage of light between the first environment and the second environment, and wherein the ambient variable impact comprises one or both a depth of casting of shadow and a level of reflecting light.

14. The sculptural slat structure of claim 9, wherein each of the plurality of substantially planar sheets sculpted in two axes also comprise variable dimensions along a third axis, and wherein the core portion is located interior to the substantially planar sheet.

15. The sculptural slat structure of claim 9, wherein each of the plurality of sculptural slats further comprise a second sculptural edge opposite to the first sculptural edge, wherein the substantially planar sheet further comprises a third functional zone comprising a second sculptural portion extending from the core portion to the second sculptural edge, wherein the third functional zone is configured to cast a second sculptural shadow onto one or more adjacent sculptural slats and surfaces in the first or second environment.

16. A method for manufacturing a sculptural slat structure comprising the steps of:
receiving installation data comprising one or more height data, width data, and depth data related to an installation site;
receiving sculptural edge data comprising at least sculptural design data;
receiving installation environment data comprising at least a first environment data and a second environment data, wherein the sculptural slat structure is configured to be installed between a first environment and a second environment;
receiving slattable object integration mechanism data comprising at least slattable object integration mechanism type;
generating rough sculptural slat specification data comprising at least sculptural slat width data and sculptural edge design, wherein a sculptural slat comprises a substantially planar sheet comprising four edges, wherein at least one of the four edges comprises a first aligned edge and a first sculptural edge, and wherein the substantially planar sheet comprises at least:
a first functional zone comprising a core portion of the sculptural slat and a slattable object integration feature, wherein the first functional zone is configured to control at least one ambient variable between the first environment and the second environment;
and a second functional zone comprising a first sculptural portion extending from the core portion to the first sculptural edge, wherein the second functional zone is configured to cast a sculptural shadow onto one or more adjacent sculptural slats and surfaces in the first or second environment;
generating specifications for the first functional zone, comprising slattable object integration feature specifications and alignment specifications, wherein alignment specifications define the first aligned edge, wherein adjacent sculptural slats are aligned at the first aligned edge when installed; and
generating refined sculptural slat specifications that define augmentation of the first functional zone and the second functional zone, wherein the refined sculptural slat specifications are based at least in part on the at least one ambient variable, the slattable object integration mechanism, installation environment data, and the rough sculptural slat specification data.

17. The method of claim 16, further comprising:
generating slattable object specifications comprising at least a slattable object type, height data, depth data, and width data, wherein the slattable object specifications are based at least in part on one or more of the installation data, sculptural edge data, and generated rough sculptural slat specifications;
generating sculptural slat installation data, wherein the sculptural slat installation data comprises at least a quantity of sculptural slats and alignment specifications defining at least installation distance between adjacent sculptural slats and installation distance between sculptural slats and the slattable object; and
generating slattable object integration mechanism specifications comprising at least slattable object integration mechanism type and spacing specifications defining installation areas within the first functional zone.

18. The method of claim 17, wherein the slattable integration mechanism specifications further comprise orientation data defining orientation ranges of each of the sculptural slats within the slattable object.

19. The method of claim 17, further comprising receiving ambient variable impact range specification preferences defining a potential range of ambient variable impact based on one or more of the installation data, sculptural slat material, the installation environment data, and sculptural edge data, wherein the ambient variable impact range specifications at least partially define the slattable integration mechanism specifications and refined sculptural slat specifications.

20. The method of claim 16, further comprising the step of executing manufacturing of one or more of the sculptural slat, the slattable object, the sculptural slat structure, or slattable object integration mechanism.
